(19) United States
(12) Patent Application Publication
(10) Pub. No.: US 2005/0003188 A1
(43) Pub. Date: Jan. 6, 2005

(54) Thermolytic synthesis of inorganic oxides imprinted with functional moieties

(75) Inventors: John D. Bass, Berkeley, CA (US); Alexander Katz, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Berkeley, CA (US)

(21) Appl. No.: 10/806,825

(22) Filed: Mar. 22, 2004

Related U.S. Application Data
(60) Provisional application No. 60/456,828, filed on Mar. 21, 2003.

(51) Int. Cl. B32B 15/02; B05D 7/00

(52) U.S. Cl. 428/402; 428/403; 427/215

(57) ABSTRACT

Inorganic oxides, particularly silica or germania or inorganic oxides containing silica and/or germania, are imprinted with one or a plurality of functional moieties such as amine and/or thiol groups by a process featuring incorporating such groups into the oxide by use of a thermally labile material containing a protecting group for the amine or thiol, followed by removal of the thermally labile moiety by thermolysis. The resulting products are inorganic oxide substrates or bulk inorganic oxides imprinted with the functional moieties. A plurality of such moieties may be imprinted on a substrate in an order fashion using a polymeric imprinting compound, and may then be used as a templated array of functional moieties to which ordered metallic nanostructures may be constructed.

### CROSS-REFERENCE TO RELATED APPLICATIONS

This application claims priority of U.S. provisional application 60/456,828 filed Mar. 21, 2003; the total contents of said application are hereby incorporated herein.

### BACKGROUND OF THE INVENTION

This invention relates to the synthesis of materials that comprise an inorganic oxide imprinted with a functional moiety or moieties. Such substances are known in general, and are described in patents and publications mentioned below. They have been found useful in numerous applications, including catalysis, adsorption, separation, and the like. Imprinted moieties have ranged from enzymes and enzymatic derivatives to simple functional moieties such as amines. Comprehensive reviews of this technology are found in Wulff et al. (2002)¹ and Davis et al. (1996),¹ for instance.

U.S. Pat. No. 6,380,266 describes the production of functionalized imprinted materials, particularly on inorganic oxides such as silica and germanium oxide. The products are porous materials having discrete pores of a controlled size and shape, with one or more functional groups formed in the pores. Included among the functional groups that can be imprinted are various amines. Of particular interest is the production of such oxides, especially silica, having two or more functional groups (preferably of the same type such that the relationship of one of these groups to an associated pore is similar to the relationship of a second group to a different associated pore). The imprinting, and particularly the production of such imprinted multiple-but-related functional groups, is carried out by forming the oxide from an oxide precursor in the presence of an imprinting agent that contains a fragment/protecting group to which are covalently linked the functional groups to be imprinted, followed by removing the fragment by chemical cleavage of one or more cleavage sites introduced via the imprinting agent, leaving only the functional moieties.

An example of such a process is shown in Katz et al.,² which discloses the production of a silica imprinted with up to three n-aminopropyl moieties by reaction of triethoxysilane with a protected benzenetrimethanol tri-(n-propyl carbamate) to form a silica with linkages to the benzene groups, followed by deprotection by reaction with trimethylsilyl iodide (TMSI), to remove the linkages as carbon dioxide and tri-iodomethylbenzene. The resulting silica contains imprinted aminopropyl groups and may be used for catalyzing reactions, for separations, etc., as discussed, for instance in U.S. Pat. No. 6,380,266 and other references cited herein.

Thus, recent advances in the imprinting of bulk silica have successfully synthesized microporosity and chemical functional group organization at the imprinted site.² However, the limits of using an external chemical reagent, such as TMSI mentioned above, for achieving deprotection and imprint fragment removal has made it exceedingly difficult to deprotect immobilized imprint species with multiple points-of-attachment to the silica framework. For instance, in Katz et al., supra, immobilized imprints consisting of dicarbamates require significantly higher temperatures, by about 30° C., and harsher conditions for deprotection compared to immobilized imprints consisting of monocarbamates.³ Specifically, if a temperature of 40° C., which is used for the monocarbamate-containing one-point imprint of Katz et al., is used for deprotecting the dicarbamate-containing two-point material of Katz et al., almost no detectable deprotection is observed by ¹³C CP/MAS NMR spectroscopy. This phenomenon is directly related to the difficulty of causing simultaneous chemical reaction of an external reagent such as TMSI on both carbamates of the immobilized imprint species in the two-point material. By the principle of microscopic reversibility, if only one carbamate of an immobilized imprint in the two-point material deprotects (i.e. the two carbamates do not deprotect simultaneously), the reverse reaction on the deprotected carbamate can occur by which it reverts back to its protected form. This can occur because immobilization of the imprint species to the silica via the other, unreacted carbamate species positions the deprotected moiety for the reverse reaction. Thus, to produce immobilized multiple-point imprints the deprotection must happen in an irreversible manner and simultaneously. This phenomenon is further accentuated and amplified in the three-point material in Katz et al., which comprises a tricarbamate-containing immobilized imprint species. Despite a 10° C. higher reaction temperature compared with the two-point material, only 14% of the sites in the three point material of Katz et al. could be deprotected.² Other authors also disclose the imprinting of up to three primary amines in silica containing silanol groups, using an external chemical reagent for causing deprotection, such as LiAlH₄⁴ in bulk silica and HCl⁵ on the surface of silica. Dufaud et al. disclose the imprinting of thiols and thiol pairs on the surface of silica using an external chemical reductant for causing deprotection.⁶ However, it is clear from these and other examples in the literature that the imprinting of multiple chemical functional groups for four or more chemical functional groups per imprint remains a challenge that has been constrained to date by the limits of using an external chemical reagent for achieving deprotection in imprinting. This limit of being able to deprotect a maximum of three chemical functional groups per immobilized imprint is the same one that is imposed for the maximum molecularity of an elementary chemical reaction, which also must be achieved in a single concerted step by definition of its being elementary. In elementary reactions, there are many examples involving bimolecular reactions (corresponding to the case of two chemical functional groups per imprint), relatively few examples involving three chemical groups reacting in a step (corresponding to the case of three chemical functional groups per imprint) and no known examples of four or more chemical groups reacting in a single step (corresponding to the case of four or more chemical functional groups per imprint). Thus, it is reasonable to conclude based on this comparison that the deprotection of four or more chemical functional groups per immobilized imprint would be an extremely unlikely event using conventional methods of imprinting, which rely on an external chemical reagent for deprotection.

### BRIEF SUMMARY OF THE INVENTION

In general, this invention makes possible the imprinting of multiple organic functional groups on an inorganic oxide, and imprinting of functional groups on such oxides in general, by using thermolytic treatment to cause deprotection preferably in the presence of an acidic environment, rather than a chemical reagent. The thermolytic treatment makes it possible to simultaneously deprotect a large number of points on an imprint. This is accomplished by the use of a thermally labile protecting group in imprinting an inorganic oxide with one or, preferably, a plurality of functional moieties per imprint (which may be the same or different moieties). Aspects of the invention include processes and products, including intermediate products and processes. In the various embodiments of this invention, the functional moiety is included in an imprinting compound which also contains one or a plurality of thermally labile protecting groups for the functional moiety or moieties, with each protecting group being connected to a silicon- or germanium-containing moiety capable of serving as a linker for the imprinting compound to the inorganic oxide. The imprinting compound is contacted with the inorganic oxide surface or an inorganic oxide colloidal particle as in surface imprinting,⁵ or a molecular source of inorganic oxide as in bulk imprinting,² as described below, and the two are allowed to react. The resulting material is then subjected to thermolysis, preferably in the presence of an acidic environment, to remove the labile portion of the overall material (this step is also referred to as “thermolytic deprotection”), resulting in a material that comprises the one or, preferably, plurality of chemical functional groups imprinted on the inorganic oxide. Importantly, unlike methods relying on an external chemical reagent for achieving deprotection as described in the prior art, in the present invention using thermolysis there is no increased difficulty in deprotecting multiple chemical functional groups. The same reaction conditions for deprotection that are used to deprotect an immobilized imprint containing one chemical functional group per imprint can be used to deprotect an immobilized imprint containing multiple chemical functional groups. This is demonstrated in the specific examples below.

In one embodiment, the invention therefore comprises a process for producing an inorganic oxide imprinted with a plurality of functional groups, comprising:
(a) contacting the inorganic oxide or a source thereof with an imprinting compound comprising (i) a plurality of functional moieties to be imprinted, (ii) a plurality of thermally labile protecting groups and (iii) a silicon- or germanium-containing moiety capable of serving as a linker for the imprinting compound to the inorganic oxide to form an inorganic oxide structure comprising immobilized imprinting compound; and
(b) removing a thermally labile portion of the imprinting compound from the oxide structure by thermolysis.

In another embodiment the invention comprises a process for producing an inorganic oxide imprinted with a functional group, preferably with individual isolated functional groups, comprising:
(a) contacting the inorganic oxide or a source thereof with an imprinting compound comprising (i) a functional moiety to be imprinted, (ii) a thermally labile protecting group and (iii) a silicon- or germanium-containing moiety capable of serving as a linker for the imprinting compound to the inorganic oxide to form an inorganic oxide structure comprising immobilized imprinting compound; and
(b) removing a thermally labile portion of the imprinting compound from the oxide structure by thermolysis.

In some embodiments of the invention the imprinted inorganic oxide is a bulk inorganic oxide. Typically imprinted bulk oxides are produced by a process in which the imprinting is performed concomitantly with the formation of the oxide from one or more sources or precursors. The imprinted moieties are contained in voids in the material left by the removal of the thermally labile portion of the imprinting compound, and each of these moieties is covalently bound to the oxide via the silicon- or germanium-containing moieties of the imprinting compound. In such a case the process comprises:
(a) copolymerizing a source of the organic oxide with an imprinting compound containing (i) one or, preferably, a plurality of functional moieties to be imprinted, (ii) one or a plurality of thermally labile protecting groups, and (iii) a silicon- or germanium-containing moiety capable of serving as a linker for the imprinting compound to the inorganic oxide to form an inorganic oxide structure comprising immobilized imprinting compound; and
(b) removing a thermally labile portion of the immobilized imprinting compound from the oxide structure by thermolysis.

In another embodiment the imprinted inorganic oxide comprises a substrate that comprises the oxide. In this embodiment the functional moieties are bound to the surface of the substrate via the silicon- or germanium-containing moieties of the imprinting compound. This process comprises:
(a) contacting a substrate comprising the inorganic oxide with an imprinting compound comprising (i) one or, preferably, a plurality of functional moieties to be imprinted, (ii) one or, preferably, a plurality of thermally labile protecting groups for the functional moieties, and (iii) a silicon- or germanium-containing moiety capable of serving as a linker for the imprinting compound to the inorganic oxide to form an inorganic oxide structure comprising immobilized imprinting compound; and
(b) removing a thermally labile portion of the imprinting compound by means of thermolysis.

In a preferred embodiment of this process the inorganic oxide is in the form of a substrate and the imprinting compound is an oligomer or polymer preferably a long-chain multi-block copolymer, that contains multiple functional moieties in an ordered manner, so that the resulting imprinted product contains a multiplicity of functional moieties arranged in a similar ordered manner.

In one embodiment the product of the process comprises an inorganic oxide-containing substrate that has multiple functional moieties (including one or more different types of functional moieties) bound to it through the silicon- or germanium-containing portion of the imprinting compound.

In one aspect of the invention, the products are hydrophilic bulk oxides that have little or no capping of free silanol or other hydroxyl groups. In one embodiment of this aspect, the functional groups comprise primary amine (—NH₂) groups.

The products of the invention also include products such as those mentioned above in which the functional groups have been derivatized to provide other groups, or reacted with, for example metal ions, to provide catalytic materials or substrates, or subsequently reacted with other materials.

### DESCRIPTION OF THE DRAWINGS

FIG. 1 represents a scheme for the synthesis of imprinted silica containing two primary amines per imprinted site, according to the invention.

FIG. 2 represents a scheme for the synthesis of imprinted silica containing a thiol-amine pair per imprinted site, according to the invention.

FIG. 3 represents a thermolytic imprinting scheme for the organization of multiple functional groups in an array using an oligomer- or polymer-based imprint as a template.

FIG. 4 depicts typical solid-state ¹³C CP/MAS NMR spectra of imprinted materials. Asterisks denote resonances corresponding to a trace of ethoxy functionality. A mesoporous material synthesized with imprint 1 (a) before and (b) after thermolysis, a microporous material synthesized with imprint 2 (c) before and (d) after thermolysis, and a mesoporous material synthesized with imprint 3 (e) before and (f) after thermolysis. A 7 mm probe was used with a cross polarization contact time of 1 ms.

FIG. 5 depicts solid-state ²⁹Si NMR spectra of a mesoporous material imprinted with 1. A comparison of CP/MAS spectra of the material (a) after and (b) prior to deprotection showing that the T³ region of the spectrum centered at −66 ppm remains unchanged under the mild heating required for thermolysis. (c) Bloch decay spectrum shows a Q⁴ to Q³ ratio of 2.5 to 1 indicating that 72% of the silica is fully condensed. CP/MAS NMR spectra were collected using a cross polarization contact time of 2 ms. Bloch decay spectrum was collected with a repetition delay of 300 s.

FIG. 6 contains (a) high-resolution thermogravimetric analysis of the thermolysis of a mesoporous material imprinted with 1 and (b) the corresponding mass spectrum showing the evolution of the 41 amu allyl fragment corresponding to isobutene.

FIG. 7 contains (a) non-aqueous potentiometric titration of a mesoporous material imprinted with 3. (b) the derivative of the potential with respect to acid volume added demonstrates the location of the equivalence point. (c) physical adsorption/desorption isotherms of nitrogen at 77 K using a mesoporous material imprinted with 3. (d) the corresponding BJH pore-size distribution based on the desorption branch of the isotherm in (c).

FIG. 8 contains Diffuse-reflectance UV/Vis spectra of mesoporous materials imprinted with 2 after treatment with salicylaldehyde. These spectra demonstrate (a) a band at 392 nm in a thermolyzed material and absence of this band in (b) a material prior to carbamate deprotection and (c) a material prior to carbamate deprotection that was not treated with salicylaldehyde.

FIG. 9 contains steady-state fluorescence emission spectra of mesoporous materials synthesized with two mole percent of imprint 2 relative to TEOS (______) and surface functionalized amines ( - - - - - ) upon covalent binding of 4—pyrenebutyraldehyde at loading of 0.15 mmol/g.

FIG. 10 depicts typical solid-state ¹³C CP/MAS NMR spectra of thiol imprinted materials before deprotection and the same material after thermolytic deprotection.

FIG. 11 contains a thermogravimetric analysis of the thermolysis of immobilized imprint 4 on silica.

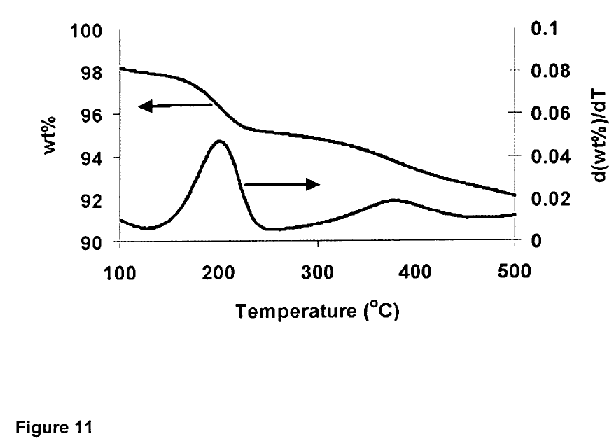

FIG. 12 contains a thermogravimetric analysis of the thermolysis of immobilized imprint 5 on silica.

FIG. 13 contains solid-state UV/Vis spectra of immobilized imprint 5 before deprotection and the same material after thermolysis, showing deprotection of the xanthate protecting group moiety.

FIG. 14 depicts two independent routs for production according to the invention, of imprinted materials containing a catalytically active palladium complex.

FIG. 15 depicts solid-state UV/visible spectra of materials shown in FIG. 14.

FIG. 16 depicts conversion of bromobenzene using the two palladium-containing catalysts shown in FIG. 14.

### DETAILED DESCRIPTION OF THE INVENTION

In general, this invention relates to the use of thermally labile protecting groups in imprinting an inorganic oxide with one or, preferably, a plurality, of functional moieties (which may be the same or different moieties). Aspects of the invention include processes and products, including intermediate products and processes. In the various embodiments of this invention, the functional moiety (or, preferably, plurality of moieties) is included in an imprinting compound which also contains one or a plurality of thermally labile protecting groups for the functional moiety or moieties, and a silicon- or germanium-containing moiety that is capable of serving as a linker for the imprinting compound to the inorganic oxide. The imprinting compound is contacted with a material that comprises the inorganic oxide, or with a molecular source of inorganic oxide, as described below, and the two are allowed to react. The resulting material is then subjected to a thermolysis step to remove the labile portion of the overall material (this step is also referred to as “thermolytic deprotection”), resulting in a material that comprises the one or, preferably plurality of, functional groups imprinted on the inorganic oxide.

The functional groups that may be imprinted on inorganic oxides by processes of this invention include amine, thiol, isocyanate,⁷ carboxyl,⁸ hydroxyl,^{9,10} phenoxyl,¹¹ and inorganic acids such as phosphate¹² and titanate¹³. The functional group may be attached or bonded directly to the silicon- or germanium-containing linker but preferably is bonded to it through a chain comprising one or more carbon atoms.

The thermally labile portions of the imprinting compound are ones that can serve to protect the functional group from reacting when that is not desired, and are removed from the product of the imprinting process by thermolysis, as described below. The thermally labile protecting group is of the type generally known to be suitable as a protecting group for the functional moiety in question, for example, a tertiary carbamate protecting group for a primary or secondary amine,¹⁴ a xanthate protecting group for a thiol,¹⁵ a carbamate of an aryl alcohol protecting group for an isocyanate,⁷ an ester of a tertiary alcohol protecting group for a carboxyl,⁸ an ether of a tertiary alcohol protecting group for a hydroxyl and phenoxyl,⁹⁻¹⁰ and tertiary alkoxy protecting groups for inorganic acids such as those of phosphate and titanate.^{12,13} As will be discussed below, the protecting group preferably includes a tertiary alkyl moiety such as t-butyl for primary or secondary amines, whereas for thiols it preferably includes a secondary alkyl moiety such as isopropyl. As discussed in U.S. Pat. No. 4,491,628 an acidic environment surrounding the protecting group can be used to significantly lower the temperatures required for thermolysis. Thus, an acidic environment, such as that provided by silanols in silica in the vicinity of the immobilized imprint, is preferred in that it can significantly lower the temperatures required for thermolysis to about 90° C. Other acids known to do this in the art include Lewis acids such as ceric ammonium nitrate, which can lower the temperature required for thermolysis to about room temperature, in addition to the Bronsted-acidic silanols mentioned above.

In one embodiment the imprinted inorganic oxide is a bulk inorganic oxide. As is known in the art, imprinted bulk oxides typically are produced by a process in which imprint condensation is performed concomitantly with the formation of the oxide, starting from one or more molecular sources or precursors. The imprinted moiety or, preferably moieties are contained in voids in the material left by the removal of the thermally labile portion of the imprinting compound, and are covalently immobilized to the oxide via the silicon—or germanium—containing moieties of the imprinting compound.

In another embodiment, as discussed below, the imprinted inorganic oxide comprises a substrate that comprises the oxide. The substrate can have macroscopic dimensions as in the case of a porous silica particle or it may have colloidal dimensions as small as a few nanometers as in the case of a non-porous Stöber silica particle or a commercially available silica particle such as Cabosil® EH-5, Aerosil® 380, or other non-porous colloidal silica. Preferably, the substrate is a surface, such as a generally planar surface, and may be composed of one or more inorganic oxides or may be composed of any material having an inorganic oxide deposited on or bound to the surface by any convenient method. In this embodiment, the functional moieties of the imprinting compound are bonded to the surface of the substrate via the silicon-or germanium-containing moiety of the imprinting compound.

Ki et al., J.A.C.S. 124: 14838 (2002)₇ disclosed carrying out a process in which isocyanate groups were imprinted on the surface of silica particles using a carbamate formed with the phenolic moiety of estrone to provide a thermally cleavable bond, followed by heating the material to remove the estrone moiety. The cavity left behind after estrone removal was used as a specific adsorption site for the rebinding of estrone, which was contemplated to be useful for sensing applications. Ki et al. first sought to produce their product by a bulk imprinting process; however this attempt failed; they were unsuccessful at imprinting in the interior of the silica particles because they were unable to achieve removal of the imprint fragment during deprotection. To overcome this problem, they used a surface imprinting procedure in which the imprint was immobilized on silica particles that had been formed by silica nucleation. In any case, even with surface imprinting, Ki et al. did not use any other imprinting compounds and produced only imprints with a single functional moiety, namely an isocyanate.

In a preferred embodiment of this aspect of the invention the imprinting compound comprises multiple functional moieties, which become bound to the surface of the substrate via the silicon- or germanium-containing moiety.

In a particularly preferred embodiment of this process the imprinting compound is an oligomer or polymer, preferably a long-chain multi-block copolymer, that contains one or more types of functional moieties arranged in an ordered manner, so that the resulting imprinted product contains a multiplicity of functional moieties arranged in a similar ordered manner. In one embodiment the product of the process comprises an inorganic oxide-containing substrate that has one or more functional moieties (including one or more different types of functional moieties) in an organized array that are bound to it through the silicon- or germanium-containing portion of the imprinting compound.

The products of the invention also include products such as those just mentioned (both bulk inorganic oxides and substrates) in which the functional groups have been derivatized to provide other groups, or reacted with, for example metal ions, to provide catalytic materials or substrates, or reacted with other materials.

Inorganic oxides suitable for use in the process, both in the production of the bulk oxide and in the treatment of inorganic oxide-containing substrates, include silica, germanium oxide, and other inorganic oxides such as alumina, ceria, indium-tin-oxide (ITO), zirconia, titania, aluminophosphates and silicaaluminophosphates, and mixtures thereof. However, the preferred materials for use in this process are silicas, such as amorphous silica.

The thermolysis step of the processes of this invention is preferably performed by heating the material at temperatures of from about 120 to about 300° C., preferably from about 140 to about 250° C., and preferably for a period of about 3 hours. This step can be performed under an atmosphere of an inert gas, such as nitrogen or argon, or under a vacuum. Thermolysis can be performed in an air atmosphere without causing oxidation of the tether and functional moiety, so long as temperatures below 275° C. are used.

The thermolysis step can alternatively be performed by subjecting the material to electromagnetic radiation or other energy source such as sonication, infrared radiation, ultraviolet radiation, etc., such that, as is known in the art, a localized heating occurs, sufficient to cause the necessary deprotection of the imprinting compound and removal of a thermally labile fragment or portion of it. Such sensitizers and the use of an acidic environment to lower the temperature necessary for thermolysis are generally known in the art and are described in U.S. Pat. No. 4,491,628.

For purposes of convenience, much of the detailed description that follows, including many of the examples, is phrased primarily in terms of the production of bulk silica imprinted with n-aminopropyl groups. However, the invention is not at all limited to this specific embodiment, but insofar as bulk oxide products are concerned relates generally to amorphous inorganic oxides having discrete voids of controlled size and shape with a plurality of spatially organized functional groups, most particularly amine and/or thiol groups. The same procedure can be extended to other known thermolyzable protecting groups for organizing isocyanates, carboxyl, hydroxyl, phenoxyl, and inorganic acids as mentioned above. The term “discrete” means that the functionalized void spaces are isolated and locally surrounded by the amorphous material. In other words, the voids are spaced apart within the amorphous material such that binding of substrate molecules to these voids results in a substantial portion of the bound molecules to be separated from one another.

For production of bulk oxides, the process generally involves the use of imprint molecules or compounds that are designed to preferably allow for the formation of voids of controlled size and shape once the thermolyzable fragment of the compound is removed from the oxide (this is termed “deprotection”), leaving the deprotected functional groups behind.

The thermolysis of carbamates such as carbamates of tertiary alcohols, or of other groups according to this invention, as will be described below, results in single-site materials consisting of either isolated amines or multiple organized amines within an imprinted site. Similarly, the thermolysis of xanthates produces single-site materials consisting of either isolated thiols or multiple organized thiols within an imprinted site. Those products in which silanol or other hydroxyl functionality is retained allow for the facile incorporation of polar reagents and provide a chemical building block for the tuning of framework properties that is independent of the creation of the active site region by the removal of the imprint. Changes in framework makeup result in alterations of the intermolecular forces proximal to the active imprinted amines or thiols and consequently alter transition behaviors occurring at these sites.

As known in the art, imprinted bulk silica material is formed by condensing an imprint compound with a source of silica. The reaction conditions are preferably acidic to minimize the differences in the hydrolysis rates between organosilanes and silanes for a more homogenous incorporation of the imprint compound within the silica gel framework.

The source of silica may be silica itself or any silica precursor such as silicates, silica hydrogel, silicic acid, colloidal silica, fumed silicas, tetraalkyl orthosilicates, and silica hydroxides.

The product of the condensation reaction between the source of silica and the imprint compound is a material in which the imprint compound has been covalently incorporated therein and cross-linked therewith, such that the imprint compound is immobilized to the silica material. This silica gel product is sometimes referred to as the “as-made material” and requires further processing before use. Briefly, the as-made material is extracted to remove residual moisture (“extracted material”) and, in some embodiments of the invention, is capped to remove any free hydroxyl functionalities (“capped material”) using standard methods. Whether or not capping has been carried out, the imprint compound is then removed from the silica gel by thermolysis.

Practice of the process of the invention yields amorphous silica having discrete voids that are approximately complementary in size and shape to the thermolyzable fragment of the imprint compound, each of these voids having one or, preferably, a plurality of spatially organized organic moieties contained therein. In preferred embodiments, the voids are of substantially similar size and shape. The organic moieties are spatially organized within the voids as a result of being part of an imprint compound that is cross-linked to the silica framework.

Optionally, following deprotection, the organic moieties incorporated into the pores may be further reacted to either modify existing functionalities or to add new functionalities. For example, amine groups may be derivatized or reacted to form a variety of other organic groups (e.g., alkylation or conversion into amides, ureas, or carbamates). Because the molecular framework of the amorphous silica is generally robust to a variety of synthetic conditions, standard organic chemistry protocols may be used in most cases. Illustrative examples of such protocols may be found, for example, in “Advanced Organic Chemistry,” Third Edition (1985) by Jerry March, which is incorporated herein by reference.

Further functionalization may also include the formation of a coordination complex between at least one of the incorporated organic moieties and a metal or metal-containing ion or a semiconductor such as cadmium sulfide. In the simplest case, a functional group such as an amine, a thiol or a carboxyl group can interact with one or more metal-containing ions to form active metal centers. For example, the one or more organized amines within the inventive amorphous silica may be further functionalized by contacting the amine functionalized silica with a source of a metal-containing ion such as Al³⁺Ag⁺, Co²⁺, Cu²⁺, Fe³⁺, Hg²⁺, Mn²⁺, Ni²⁺, UO₂₊ and Zn²⁺. The resulting metal functionalized silica may then be used for a variety of metal-mediated reactions such as oxidation and reduction. In particular, because of their ability to directly bind oxygen, Cu²⁺ and Fe³⁺ may be used to activate oxygen in a number of oxidative reactions. In addition, as known in the art, a variety of organic moieties may act as a ligand to form an organometallic complex with a transition metal. As used herein, a transition metal is any one of the following elements: scandium, yttrium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, and gold.

Illustrative examples of suitable ligands for the metals include but are not limited to alkyl, aryl, vinyl, allyl, cyclopentadienyl, pentacyclopentadienyl, cyclohexadienyl, phosphine, amine, nitrile, isonitrile, diene, arene, carbonyl, carbene, alkene, alkyne, cyclobutadiene, cycloheptadiene, alkylidene, halide, and combinations thereof. An overview of transition metals in organic chemistry may be found in “Transition Metals in the Synthesis of Complex Organic Molecules” by Louis S. Hegedus [University Science Books (1994)]. Alternatively, the ligands may together form a moiety such as various porphyrins (for binding transition metals like iron and copper).

The coordination of a transition metal by one or more organic moieties broadens the scope of the reactions for which the compositions may be used. For example, a combination of ligands may together form a metallocene (e.g. with any one of iron, cobalt, hafnium, nickel, scandium, titanium, yttrium, and zirconium). Illustrative examples of suitable metallocenes that may be formed are found in U.S. Pat. No. 5,708,101 of John E. Bercaw and Timothy Herzog. In addition to olefin polymerization, metallocenes can participate in a wide variety of aromatic ring substitution reactions including Friedel-Crafts acylation, arylation, and sulfonation.

In another example, the one or more organic moieties may be an alkylidene or a carbene complex including ruthenium or osmium such as those described by U.S. Pat. Nos. 5,710,298, 5,312,940, and 5,342,909 issued to Grubbs and co-workers. These ruthenium or osmium complexes are used in various olefin metathesis reactions including ring-opening polymerization, ring closing polymerization, and telechelic polymerization.

There has been much interest in the use of imprinting of bulk oxides for the synthesis of selective single-site molecular receptors for specific adsorption and catalysis.^{2,3} Recent advances in the imprinting of bulk silica have successfully synthesized microporosity and chemical functional group organization at the imprinted site.^{2,3} However, progress for the synthesis of imprinted sites containing a multiplicity of chemical functional groups has been constrained to date by the limits of wet chemical modification.

In the process of the invention, bulk oxide materials are preferably synthesized via sol-gel copolymerization of the imprint organosilane with a silica source such as tetraethyl orthosilicate (TEOS). The resulting optically transparent glass is ground and heated, releasing carbon dioxide and an olefin to yield imprinted amines or thiols.

In such processes the conditions of material synthesis are chosen to control the framework porosity of the silica independent of the properties of the imprinted site. Site-isolation characteristics of the imprinted sites are controlled by combining a large excess of TEOS with imprint so as to minimize the condensation of multiple imprint species to each other. After a brief acid-catalyzed sol-gel hydrolysis in ethanol-water mixture, condensation and gelation can be conducted under basic conditions to produce mesoporosity for facile mass transport.^{16,17,18} These conditions are chosen based on our two-step acid-base sol-gel hydrolysis and condensation procedure for synthesizing bulk imprinted silica.³ Alternatively, hydrolysis and condensation can be conducted solely under acid-catalyzed conditions to yield a microporous material with immobilized imprint, as reported previously for the synthesis of bulk imprinted silica.² The ability to control the size of the framework porosity independent of the imprinted site affords greater flexibility in tailoring the final material.

This invention, in one aspect, involves the synthesis of bulk imprinted silica with a hydrophilic material framework via the use of mild heat to achieve thermolytic imprint deprotection. In order to be able to carry out the thermolytic deprotection, the process of this invention involves introducing the imprinting group as an entity that contains one or, preferably, multiple thermally labile groups, for example thermally labile carbamate protecting groups, and one or more silica- or germanium-containing moieties that are capable of serving as a linker to the inorganic oxide, which may also be either silica or germania, or may be another inorganic oxide as described above. Other thermally labile protecting groups that may be employed include a tertiary carbamate protecting group for a primary or secondary amine,¹⁴ a xanthate protecting group for a thiol,¹⁵ a carbamate of an aryl alcohol protecting group for an isocyanate,⁷ an ester of a tertiary alcohol protecting group for a carboxyl,⁸ an ether of a tertiary alcohol protecting group for a hydroxyl and phenoxyl,^{9,10} and tertiary alkoxy protecting groups for inorganic acids such as those of phosphate and titanate.^{12,13} Examples are imprints such as 1, 2 and 3 below, which contain nascent primary amines that are protected as thermally labile carbamates derived from a tertiary alcohol and an isocyanate; and 4 and 5, which contain nascent thiols that are protected as thermally labile xanthates derived from a secondary alcohol and carbon disulfide.

The tertiary alcohols used in imprints 1-3 were t-butyl alcohol (1) and 1-methylcyclohexanol (2). However, other tertiary alcohols, particularly chiral ones, such as trans-sorbrerol, (−)-alpha-terpineol, (+)-terpinen-4-ol, and 3-octanol, 3-methyl, (R) are also suitable. Other suitable chiral tertiary alcohols are the compounds having CAS numbers 99210-90-9, 39917-55-0, 320756-17-0, 294183-28-1, 152985-31-4, 62031-22-5, 60585-83-3, 28405-88-1, and 10267-19-3. Although carbamates of tertiary alcohols are preferable, it is also possible to use secondary alcohols, especially those that contain a phenyl group in the beta position. In general, any alcohol that contains a beta hydrogen can be used, since it is this hydrogen that is abstracted during the thermolysis. Similarly other secondary alcohols, particularly chiral secondary alcohols, can be used for imprints 4 and 5. Although xanthates derived from secondary alcohols are preferable, in general, it is possible to use any alcohol that contains a beta hydrogen, since it is this hydrogen that is abstracted during thermolysis.

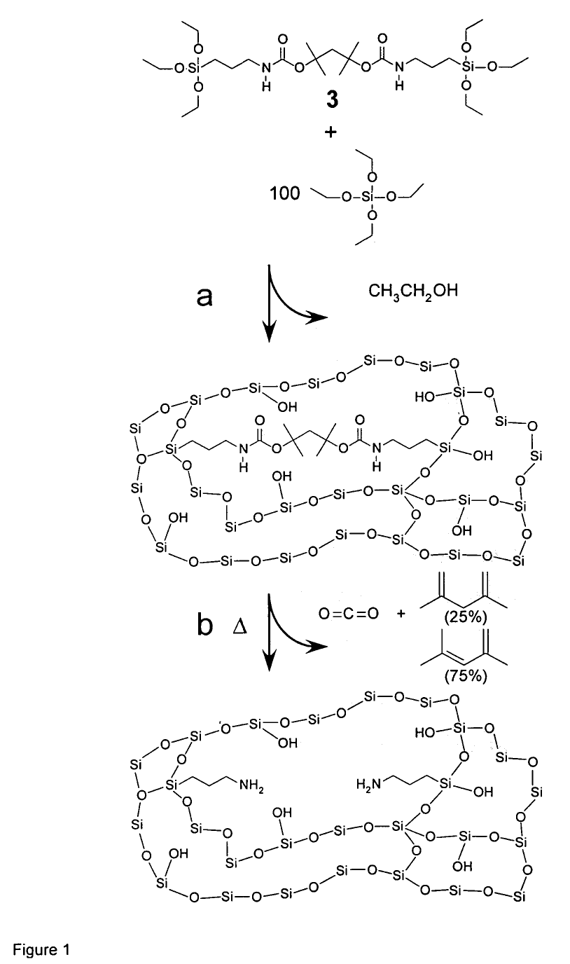

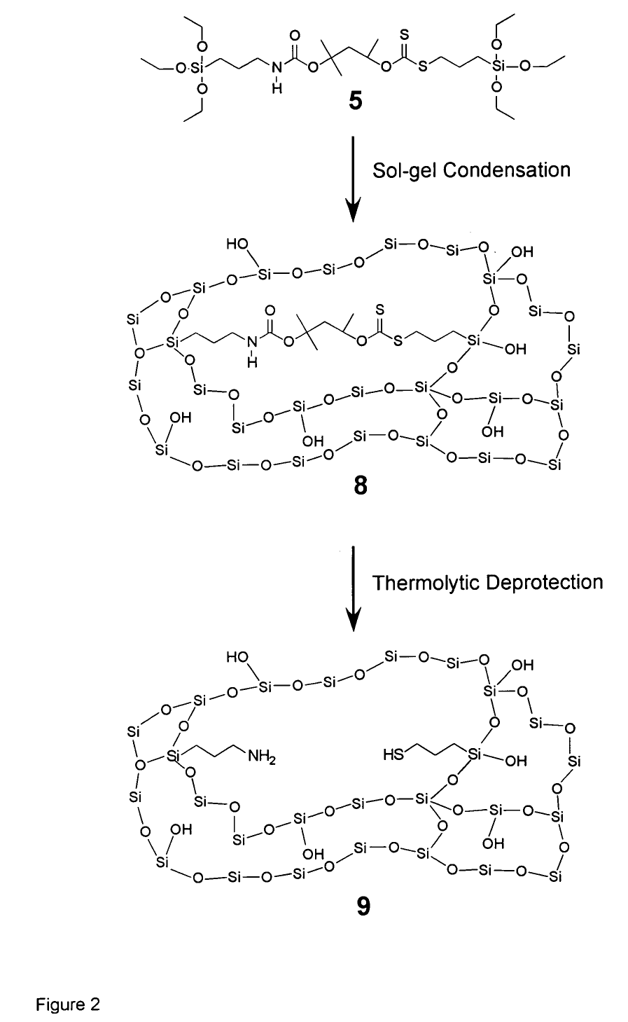

To produce products having a plurality of imprinted groups at a particular location, the protecting group must be a multifunctional group. For example, dicarbamate imprint 3 is produced using 2,4-dimethylpentane-2,4-diol. Other suitable thermally labile multifunctional protecting groups may be produced from alcohols, such as commercially available 2,3-dimethyl-2,3-butanediol and 2,5-dimethyl-2,5-hexanediol. Imprint 5 is produced from commercially available 2-methyl-2,4-pentanediol. Other suitable thermally labile multifunctional protecting groups may be produced from other molecules that preferably comprise secondary alcohols linked to a tertiary alcohol through a spacer. These may include 2-methyl-2,5,-hexanediol and 2-methyl-2,4,-hexanediol. They may also include a more rigid aromatic spacer as in CAS number 6781-43-7. The imprinting processes using imprint 3 are schematically illustrated in FIG. 1, and that using imprint 5 are shown in FIG. 2. The carbamate provides a nascent primary amine and provides spatial organization within the binding site. Imprint 1 demonstrates the feasibility of this approach with a tert-butyl carbamate (t-BOC) protecting group, a commonly used protecting group in synthetic chemistry. Similarly, imprint 2 creates porosity larger than that afforded by a t-BOC group by using a cyclohexyl moiety, and imprint 3 demonstrates the organization of multiple chemical functionalities via thermolysis, resulting in two primary amines per imprinted site.

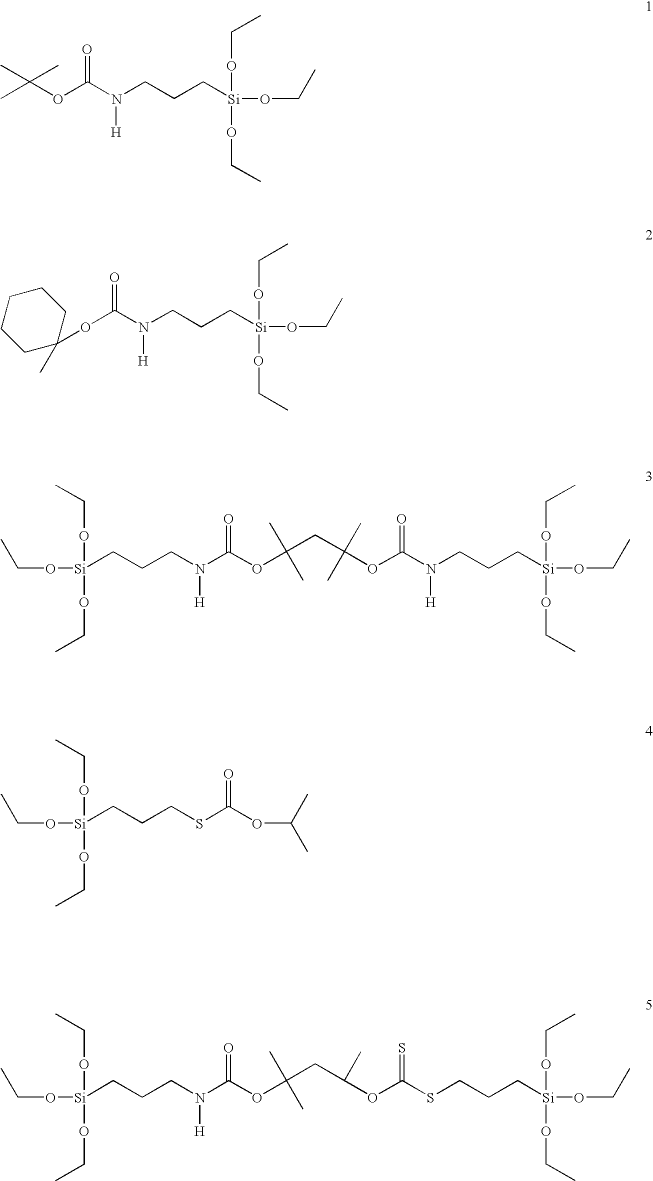

As shown in FIG. 1, a molecular precursor of silica was first co-condensed with imprint 1 in step (a) to produce an optically clear glass, releasing ethanol and water under conditions favoring sol-gel hydrolysis and condensation; then it was subjected to thermal treatment at 240° C. under an inert atmosphere, producing the imprinted amine and liberating carbon dioxide and olefin in step (b).

Thermolysis of similar carbamates has been routinely used for synthesizing primary amines in high yield and under relatively mild conditions.¹⁹ The technique has also seen application in the design of reactive polymers for lithography²⁰⁻²³ and the synthesis of inorganic-oxide materials,^{24,25} but it has not been used previously for the synthesis of imprinted materials. Other approaches to imprinting silica have used combustion of immobilized imprints to generate porosity, but this negates the possibility of organizing organic functionality.²⁶⁻²⁸ In the present invention the imprinted amine is synthesized in a single-step, does not require treatment with wet-chemical reagents, and does not require high temperatures that can compromise the integrity of organic tethers.

Xanthate protecting groups in imprints 4 and 5 provide nascent thiols and spatial organization within the binding site. The synthesis of imprinted materials containing thiol groups was accomplished via the thermolytic Chugaev reaction. Thermolysis is conducted under conditions similar to that for production of products containing amines from carbamate-containing imprints. A typical scheme is shown below, using a xanthate imprinting compound 4, which was synthesized as shown below. The synthesis depicted was accomplished using isopropanol as a representative alcohol. In general, however, any alcohol with a beta hydrogen atom may be used. Treatment with carbon disulfide of the alcohol under alkaline conditions afforded the xanthic acid salt 6 that was subsequently reacted with 3-iodotriethoxysilane to produce the organosilane imprint 7. Upon condensing imprint 7 with silica, the thermally labile xanthate protecting group was removed, yielding thiol functionality as illustrated in the second part of the scheme. This was accomplished by heating the material up to 250° C., in this case under an inert atmosphere of nitrogen.

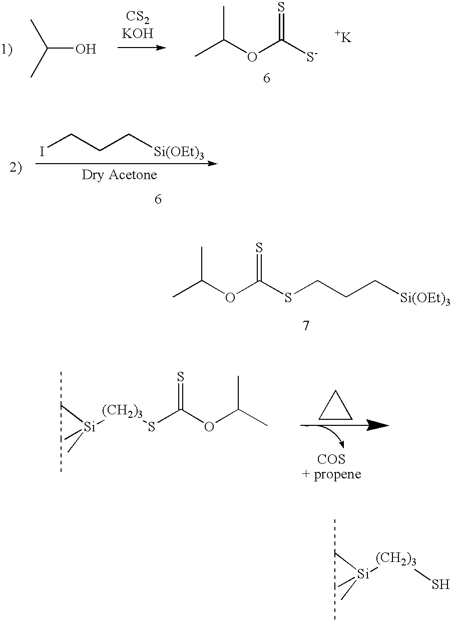

The use of imprints containing two different, orthogonal chemical functionalities also can be produced by the processes of this invention. In such materials, different functionalities in pairs or groups can be arranged with respect to each other. As an example, a material consisting of amine-thiol pairs where the amines and thiols exist in a 1 to 1 association and where the distance between the amine and thiol within a pair can be controlled was synthesized as illustrated in FIG. 2. Imprint 5, containing a nascent amine in the form of a carbamate and a nascent thiol in the form of a xanthate, was synthesized by combining the general techniques outlined previously for the synthesis of thermally labile carbamate and xanthate materials. Condensation with silica produced material 8, which was subsequently thermally deprotected to produce material 9. Thermolysis conditions are similar to those mentioned above for production of products containing amine or thiol groups.

Imprinted bulk oxides containing isolated functional groups, i.e. functional groups that are spaced apart from each other, and that are hydrophilic (i.e. that contain a significant amount of free or uncapped hydroxyl or silanol groups) are novel and form an aspect of this invention.

Surface imprinting of substrates comprising inorganic oxides is carried out using similar chemistry and conditions to those mentioned above for production of imprinted bulk oxides. Thus, amine, thiol and other functional groups (including combinations of functional groups) can be imprinted on a substrate comprising one or more inorganic oxides using imprint molecules such as those described above, with thermolytic deprotection. The substrate may be composed of one or more inorganic oxides or may be composed of any material having an inorganic oxide deposited on or bound to the surface by any convenient method.

The advantage of thermolytic deprotection over conventional methods relying on an external chemical reagent for deprotection is that it can be used to imprint substrates in a manner that produces a substrate having a large number of imprinted groups bound thereto, in an arranged or ordered manner. This is accomplished, for instance, by using as the imprinting compound an oligomer or polymer, preferably a long-chain multi-block copolymer, prepared from one or more monomers that are derived from a suitable alcohol and having nascent amine, thiol, or other chemically protected desired functional groups in a particular arrangement or spacing, connected to the polymer backbone. For example, tertiary alcohol-containing polymers described in EP 1 253 134 A1 can be used to synthesize a polycarbamate such as 10 via a procedure that is similar to that described for imprints 1-3 and 5, by treatment with 3-(triethoxysilyl)propyl isocyanate. Polymer backbones that contain repeat units with sol-gel active groups comprising silicon alkoxides are known in the art. The assembly of polymers with sol-gel active groups comprising silicon alkoxides on inorganic oxide substrate surfaces in two-dimensional ordered arrays is known and described by, for example, Park et al.²⁹ A typical length scale associated with the two-dimensional assembly as shown in Park et al. is approximately 100 nm²⁹⁻³¹. The typical minimum length scale associated with this type of two-dimensional assembly would be about 5 nm as shown in reference 31. In general, experimental techniques for the two-dimensional organization of the polymer on the substrate, as well as its alignment and arrangement of chemical functional groups within the polymer are known in the art and involve control of polymer phase behavior using composition of multi-block copolymers and other methods such as graphoepitaxy. These are summarized in references enclosed herein²⁹⁻³¹ and particularly in FIGS. 2, 5, and 6 of reference 31. Alternatively, the organization of the polymer on the substrate may involve the adsorption of isolated polymer strands comprising one-dimensional assemblies of functional moieties rather than two-dimensional assemblies. In this case, methods known in the art such as living polymerization, cationic polymerization, and anionic polymerization, may be used to impart a certain length to the polymer strand, within a narrow confine of tolerance. These may be bound to the substrate in a specific location by the use of orthogonal binding of reactive end groups on the polymer with corresponding reactive groups organized on the substrate. For example, a pair of primary amine and thiol reactive groups on the substrate, suitably positioned to be a fixed distance apart from one another that corresponds to the length of a single polymer strand in the desired bound conformation, can be used to react aldehyde and thiol reactive end groups of a polymer strand. The polymer strand in this case would then bind and adopt the conformation commensurate with the distance between the reactive groups organized on the substrate. Upon polymer binding to substrate, the primary amine reactive group on the substrate would engage and react with the aldehyde end group on the polymer to subsequently produce an imine, whereas the thiol reactive groups on substrate and polymer would engage and react with each other to synthesize a disulfide, as known to one skilled in the art of the invention.

The polymer, having pendant protected amine or other functional groups, is then contacted with the substrate under conditions such that the polymer becomes bound to the inorganic oxide in or on the substrate through the silicon- or germanium-containing moiety (sol-gel active moiety which is covalently linked to the protecting groups and undergoes sol-gel hydrolysis and condensation).

In order to produce a product having such ordered or spaced functional groups attached to a substrate it is necessary that the deprotection of practically all of the functional groups occur simultaneously; otherwise the polymer backbone will not become detached from the substrate. Such a process cannot be carried out using an external reagent for chemical deprotection because as groups become detached at least some will reattach. Thus, the products of this process are novel in and of themselves. The resulting product yields an immobilized polymer having repeat units as in 11, which is then subjected to a thermolytic deprotection step, as above, resulting in a substrate 12 having multiple attached functional groups, which are ordered or spaced as in the polymer template. The minimum length scale associated with this type of one-dimensional assembly would be typically about 0.5 nm based on the minimal footprint of the Si—(O)₃ group that is required for attachment to substrate. Those functional groups can then be derivatized, which may include reaction with metal or semiconductor ions, or otherwise treated so as to convert the functional groups into other groups, as in the case of the bulk oxides. These other groups may include suitable ligands for metal or semiconductor ions, to which can subsequently be attached the metal or semiconductor ions. This can include the synthesis of nanowires after reaction with metal ions or semiconductor molecules, by employing a suitable reduction step as is known in the art of the invention. Other functional solid structures, such as nanosized metal islands on a substrate by using polymers organized in two dimensions as a template, can also be synthesized by a similar approach. The general procedure for synthesizing either nanowires or nanosized metal islands of metal or semiconductor involves binding the metal in the form of an ion or oxide; various techniques other than binding the metal from solution can be used for this purpose and include electrodeposition and chemical vapor deposition. Subsequently, the metal is reduced with a reducing agent; sometimes this reduction can occur at elevated temperatures to promote assembly of the deposited metal ions or semiconductor molecules into a wire or nanosized island. In the latter case of the island, the chemical functional group array on the substrate is organized in two dimensions. This type of a metal/semiconductor deposition followed by reduction procedure has been implemented often in the art of the invention for synthesizing nanostructures: see for example, Nature 1996, volume 380, pages 325-328; Nature 1997, volume 389, pages 585-587; J.A.C.S. 2002, volume 124, 7642-7643.

Both the immediate products of the process, i.e. substrates having immobilized functional groups, and products prepared from them, including products having comprising nanostructures such as nanowires and nanosized islands, are novel and form aspects of this invention. Likewise, intermediate products, such as the products of the contacting of the substrate with the imprinting compound, prior to thermolytic deprotection, comprise aspects of the invention.

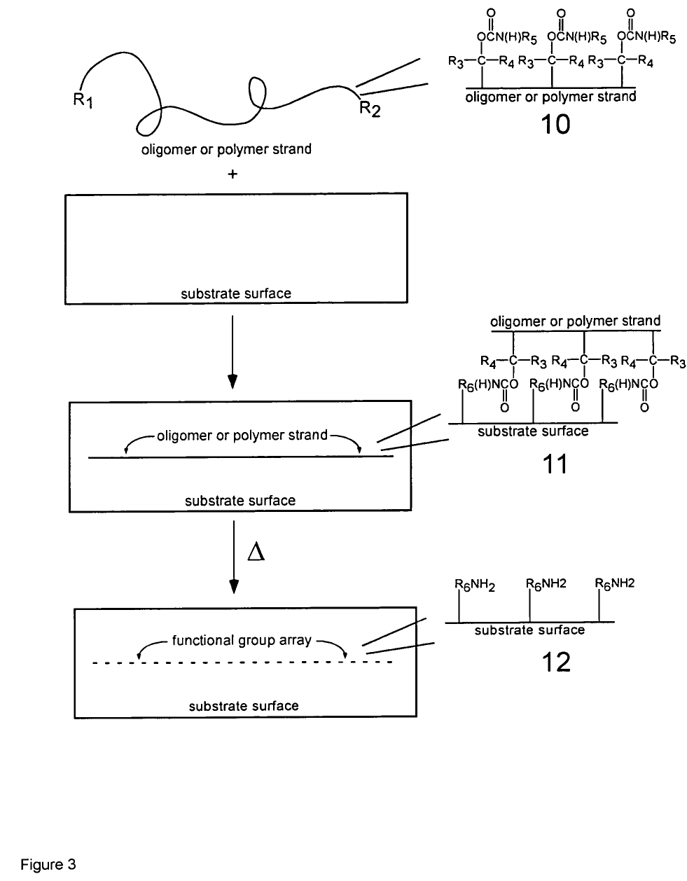

Such a process is illustrated schematically in FIG. 3. In that figure, an oligomer or polymer is prepared that has spaced carbamate groups connected to the polymer backbone through a tertiary alcohol residue, wherein R₁ and R₂ are surface-active groups that can be used to orient the polymer on the substrate surface, such that the functional moieties will be arranged in a one-dimensional array as explained above. R₃ and R₄ are general substituents on the polymer backbone, preferably making the carbamates on the polymer backbone to be tertiary carbamates. The carbamate groups are covalently bound to sol-gel active groups R₅ that contain silicon or germanium and are capable of forming a link with the oxide-containing substrate upon their hydrolysis and condensation. The linked product is shown in the second portion of this figure, with the silicon- or germanium-containing linker now designated as R₆, representing R₅ after sol-gel hydrolysis and condensation. Thermolytic treatment achieves the final product, a substrate having attached and spaced amine functional groups, whose organization has been templated by the polymer strand structure.

The oligomer or polymer at the top of FIG. 3 can contain either xanthate groups in lieu of the carbamates as described above for imprint 4, or a combination of xanthates and carbamates as described above for imprint 5. Xanthate-containing polymers are known, for example, in the production of rayon fabrics as described in U.S. Pat. No. 4,163,840. In general, the polymer can be a multi-block copolymer that contains several different types of protected groups, to yield an array containing multiple different types of chemical functional groups attached and organized on the substrate. Such a functional group arrangement containing several different types of groups can have applications in the synthesis of light-emitting diode devices, photovoltaics, and photoluminescence. In the case of a light-emitting diode device, the inorganic oxide is preferably indium-tin-oxide and aluminum oxide, since these two materials are preferably used as the anode and cathode, respectively, in organic light-emitting diodes (for example, as in EP 0 701 290).

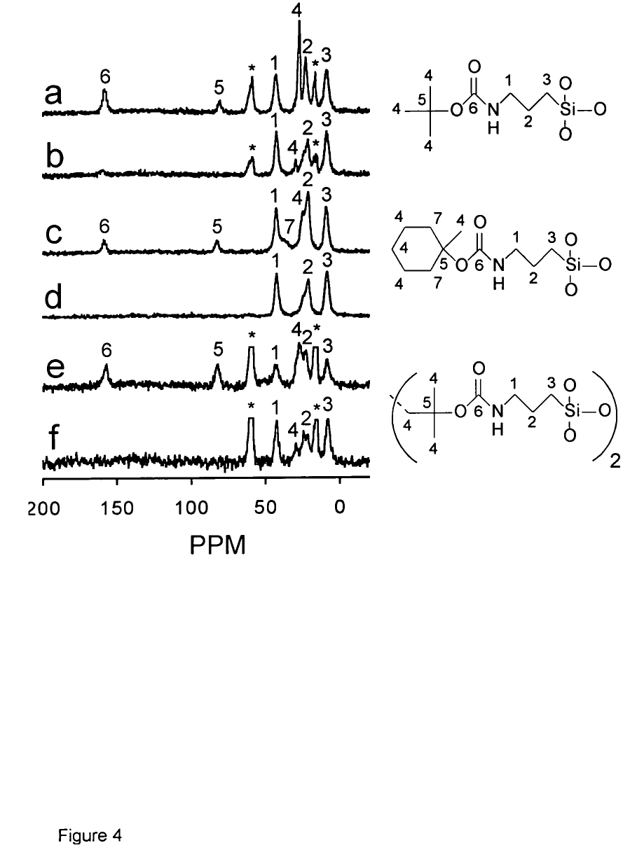

FIG. 2 shows typical ¹³C CP/MAS NMR spectra of bulk imprinted materials using imprints 1-3. In FIG. 4, asterisks denote resonances corresponding to a trace of ethoxy functionality. Spectra shown are of: a mesoporous material synthesized with imprint 1 (a) before and (b) after thermolysis, a microporous material synthesized with imprint 2 (c) before and (d) after thermolysis, and a mesoporous material synthesized with imprint 3 (e) before and (f) after thermolysis. A 7 mm probe was used with a cross polarization contact time of 1 ms. These spectra demonstrate that the carbamate remains intact immediately following materials synthesis, as shown by the tertiary carbon resonances at approximately 82 ppm (labeled 5 in FIG. 2), carbonyl resonances at approximately 158 ppm (labeled 6 in FIG. 2), and propyl tether resonances at approximately 43, 22 and 9 ppm (labeled 1, 2 and 3 in FIG. 2). The latter two groups of resonances coincide with resonance assignments in bulk imprinted silica relying on benzyl carbamates.²

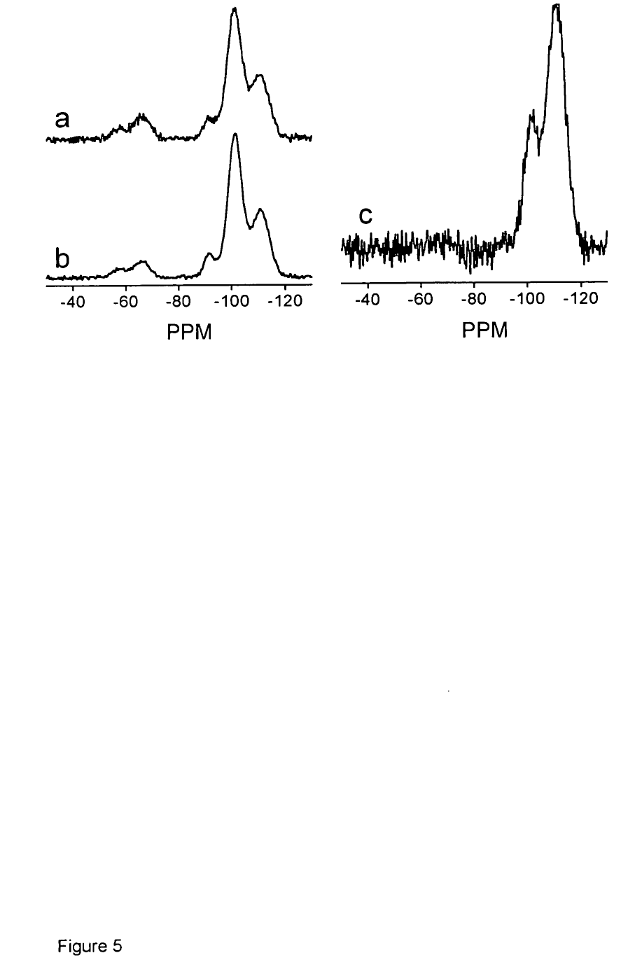

J The rigidity of imprinted materials is determined in large part by the degree of condensation and is important in the retention of imprinted information. Illustrative ²⁹Si CP/MAS and 29Si MAS NMR spectra of bulk imprinted silicas are shown in FIG. 5 for a mesoporous material imprinted with 1. A comparison of CP/MAS spectra of the material (a) after and (b) prior to deprotection showing that the T³ region of the spectrum centered at −66 ppm remains unchanged under the mild heating required for thermolysis. The Bloch decay spectrum (c) shows a Q⁴ to Q³ ratio of 2.5 to 1 indicating that 72% of the silica is fully condensed. CP/MAS NMR spectra were collected using a cross-polarization contact time of 2 ms. The Bloch decay spectrum was collected with a repetition delay of 300 s. The strong T³ resonance at approximately −66 ppm in the cross polarization experiment qualitatively shows that the imprint is highly condensed in the framework of the material as observed previously in the imprinting of bulk silica.² The ²⁹Si MAS NMR Bloch decay spectrum allows for quantitative determination of the degree of condensation within the bulk of the imprinted materials. A Q⁴ to Q³ ratio of 2.5 for this material indicates that 72% of the silica is fully condensed. There are very few observable Q² species, indicating a framework polymer network that is almost fully cross-linked. Similar silicon solid-state NMR spectra are obtained with imprints 2 and 3 as well as syntheses of materials with microporous frameworks.

Thermolysis under inert atmosphere produces primary amines directly from the immobilized imprint via carbamate deprotection while preserving the covalently bound propyl tether. This is reflected in the ¹³C CP/MAS NMR spectra, FIG. 4, by a disappearance of resonances associated with the carbamate protecting group while the resonances of the propyl tether are retained. The ²⁹Si CP/MAS NMR spectra 5a and 5b in FIG. 5 show qualitatively that the relatively mild conditions required for carbamate deprotection do not change the connectivity of the silica during thermolysis.

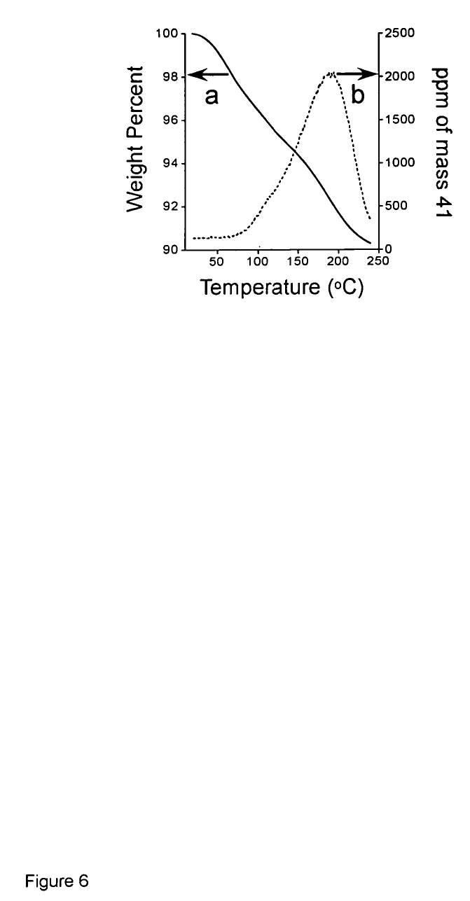

Thermolysis can be followed by high-resolution thermogravimetric analysis and mass spectrometry as shown in FIG. 6, in which a material imprinted with 1 was heated at a programmed ramp rate of 1° C./min. The rate of thermolysis becomes significant at approximately 100° C. as shown by the appearance of the allyl fragment of isobutene via mass spectroscopy (b), reaches a maximum at 185° C. and subsides sharply above 240° C. This range is typical of temperatures employed for homogeneous thermolysis of the t-BOC protecting group.⁴ The olefin thermolysis products can be isolated using a liquid nitrogen trap and detected via ¹H NMR spectroscopy. This experiment shows that 1-methylcyclohexene is released upon thermolysis of the carbamate in imprint 2 while thermolysis of imprint 3 yields a mixture of the preferred olefin product 2,4-dimethyl-1,3-pentadiene and a secondary product 2,4-dimethyl-1,4-pentadiene in a molar ratio of 3 to 1.

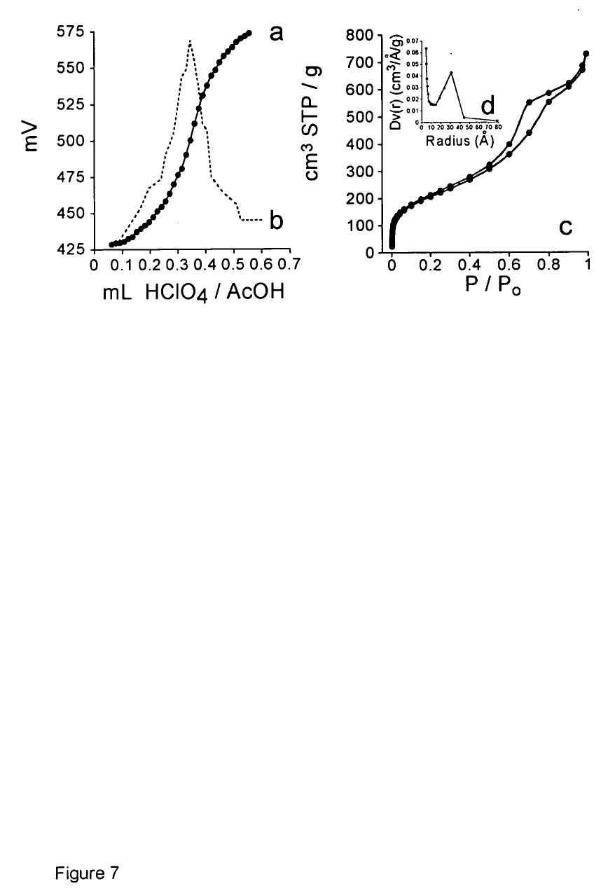

Weight loss from high resolution thermogravimetric experiment provides only an upper bound on the amount of thermolyzed imprint, due to competing weight loss from dehydration and dehydroxylation of the silica surface. However, the number of primary amines synthesized via thermolysis can be quantified using non-aqueous potentiometric titration with perchloric acid in acetic acid solvent. A typical titration curve for a material prepared with imprint 3 is shown in FIG. 7 and corresponds to a number density of 0.25 mmol amines per gram, or 87% of the total possible number of amines based on the amount of imprinted used. The curves in FIG. 7 represent: (a) non-aqueous potentiometric titration of a mesoporous material imprinted with 3; (b) the derivative of the potential with respect to acid volume added, demonstrating the location of the equivalence point; (c) physical adsorption/desorption isotherms of nitrogen at 77 K using a mesoporous material imprinted with 3; and (d) the corresponding BJH pore-size distribution based on the desorption branch of the isotherm in (c). Similar amine site densities can be achieved upon thermal deprotection of imprints 1 and 2. Importantly, titrations of mesoporous materials before thermolysis show no amines. Materials prepared with a microporous material framework, however, show a certain amount of adventitious primary amines prior to thermolysis typically corresponding to between 25% and 50% of the total number of imprinted amines present for imprints 1-3. These primary amines are synthesized during drying of the microporous glasses for extended periods of time at 40° C. Thus, materials prepared with a mesoporous framework appear to show preference for exhibiting no imprint carbamate deprotection prior to thermolysis.

An important advantage in using thermolysis over chemical methods of deprotection, as in the prior art, is the ease of deprotecting multiple functional groups within an imprinted site, as in the case of imprint 3. When using non-thermolytic methods of deprotection (i.e. TMSI), it becomes significantly more difficult to deprotect imprints with multiple points-of-attachment to the silica framework. For instance, immobilized imprints consisting of dicarbamates can undergo almost no deprotection using the same reaction conditions that are used to successfully deprotect immobilized monocarbamates.³ Using thermolysis, however, there is no increased difficulty in creating multiple functional groups from one imprint. Data in FIG. 4 and titration experiments show almost complete thermolysis for both monocarbamate, 1, and the dicarbamate, 3. These observations can be rationalized by considering thermolytic deprotection as a monomolecular event that does not require the entropically unfavorable simultaneous collision of several chemical reagents within the timescale of a deprotection event, which is in stark contrast to non-thermolytic methods of deprotection.

Nitrogen porosimetry can be used to measure the pore structure of the imprinted solids. The adsorption/desorption isotherm and corresponding Barrett-Joyner-Halenda (BJH) pore size distribution is shown in FIG. 7 for a mesoporous material imprinted with 3. This material possesses a bimodal pore-size distribution typical of imprinted mesoporous materials,³² consisting of micropores less than 10 Å in radius and mesopores with a mean radius of 32 Å. This material has a Brunauer-Emmett-Teller (BET) surface area of 740 m²/g.

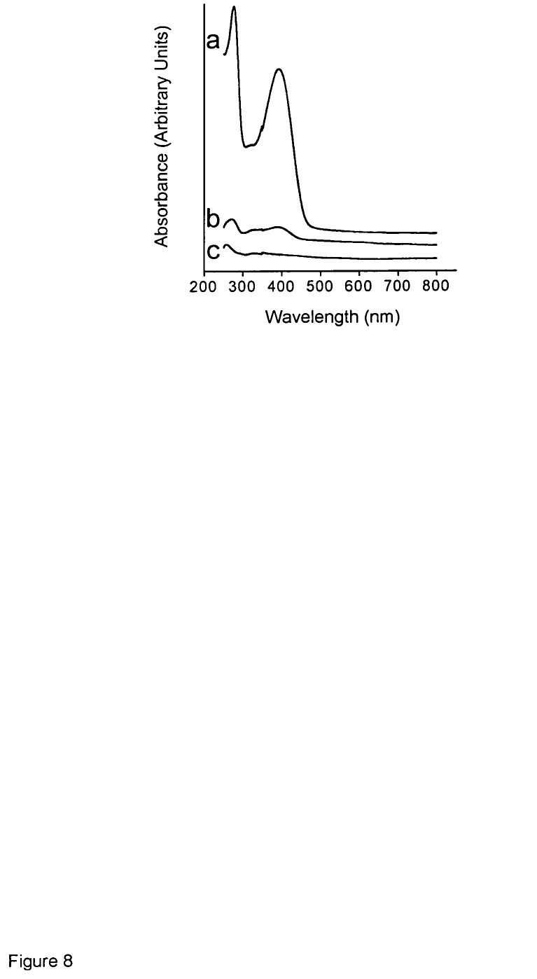

Non-aqueous potentiometric titration of imprinted amines can be corroborated with covalent binding of the probe molecule salicylaldehyde, which reacts with imprinted primary amines to form imines in quantitative yield with no background binding to the silica framework. The resulting hydrogen bond-stabilized imine is a strong chromophore and can be used as a sensitive probe for the detection of imprinted amines. The diffuse-reflectance UV/Vis spectra in FIG. 8 corroborate the titration data discussed above by showing that few primary amine sites exist prior to thermolysis in a mesoporous material. These spectra demonstrate (a) a band at 392 nm in a thermolyzed material, absence of this band in (b) a material prior to carbamate deprotection, and (c) a material prior to carbamate deprotection that was not treated with salicylaldehyde. The spectrum of the thermolyzed material in FIG. 8a shows a strong band at 392 nm similar to other reported products resulting from the condensation of salicylaldehyde with a primary amine in polar protic solvents such as ethanol (392 nm band reported).³³ Although the origin of these bands may be complex in certain circumstances,³⁴ previous investigations of imines in silicates have suggested that this band is due to a zwitterionic species 13, in which the imine is protonated.³⁵ This is consistent with assignments made in homogenous solution using polar solvents,³⁶ and assignments made in the microporous pockets of zeolites X, Y, and ZSM-5.³⁵⁻³⁷ The relatively large wavelength of this band compared to those reported for the phenol tautomer (typically around 314 nm) suggests that the imprinted amines resulting from thermolysis are located within a hydrophilic, polar local environment.

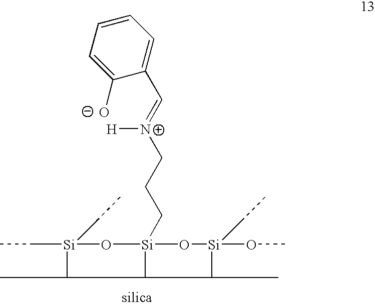

In order to investigate the degree of site-isolation in the imprinted materials, we relied on the fluorescence emission characteristics of the probe molecule, 14, which can covalently bind to the imprinted primary amines via imine linkage and is expected to be sensitive to the local density of immobilized amines.

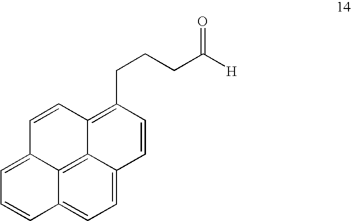

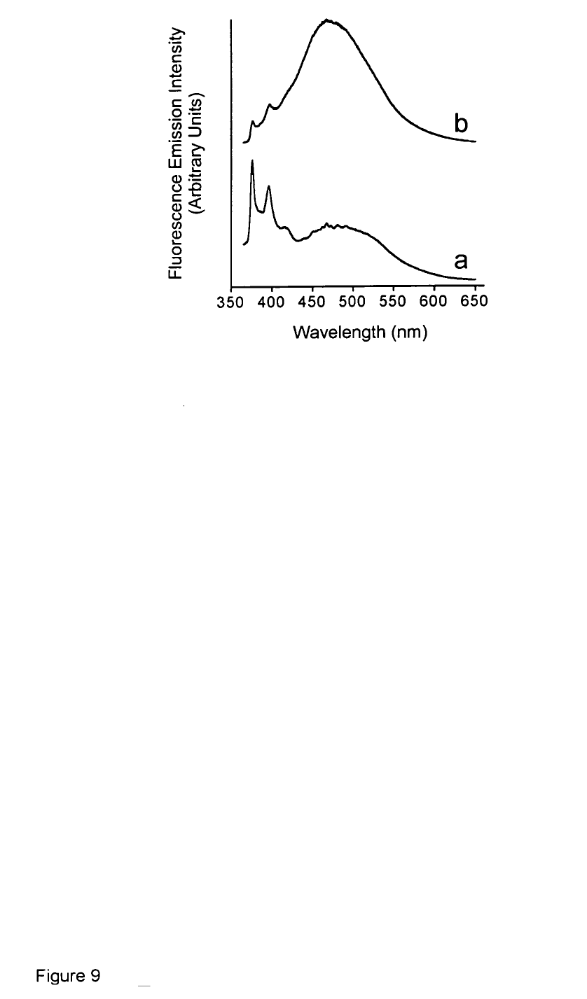

Fluorophore 14 was synthesized via a Swern oxidation of 1-pyrenebutanol with oxalyl chloride and dimethylsulfoxide.^{38,39} It was contacted with a hydrophilic mesoporous silica imprinted with 2 and a control silica comprising a monolayer of amines on the interior surface of mesoporous silica (surface-functionalized). The amount of covalently-attached 14 in both materials was determined to be 0.15 mmol/g via UV/Vis spectrophotometry, which corresponds to a loading of 68% and 12% of the sites for the imprinted and surface-functionalized materials, respectively. The fluorescence emission spectra of these pyrene-bound materials are shown in FIG. 9. This figure shows fluorescence emission spectra of a mesoporous materials synthesized with two mole percent of imprint 2 relative to TEOS (______) and surface functionalized amines ( - - - - - ) upon covalent binding of 4-pyrenebutyraldehyde at loading of 0.15 mmol/g. The imprinted material reveals mainly emission from monomer whereas the surface-functionalized material shows primarily excimer emission under the same loading of 14 per gram of material. These data indicate a high degree of site isolation in imprinted silicates that cannot be achieved by silica surface modification with aminosilanes. The difference between surface-functionalized and imprinted material in FIG. 9 is all the more significant considering the higher fractional loading of sites with 5 in the imprinted material. The pyrene emission characteristics shown in FIG. 9 are performed at much higher surface coverages compared with previous studies in imprinted materials, which reported a higher monomer to excimer emission ratio. Although they indicate that some imprinted sites in the mesoporous materials may be paired on the length scale of the pyrene probe, this length scale is approximately 16 Å and is approaching the linear distance for the separation of amines based on the bulk site density of the solid (ca 19 Å). Therefore, it is not clear whether the small amount of excimer formation observed for the imprinted material in FIG. 9 is due to excimer formation between closely adjacent sites (intersite excimer) or to the presence of a small amount of imprint molecules condensed to one another (intrasite excimer). However, based on the conditions employed in material syntheses, the latter scenario is unlikely.

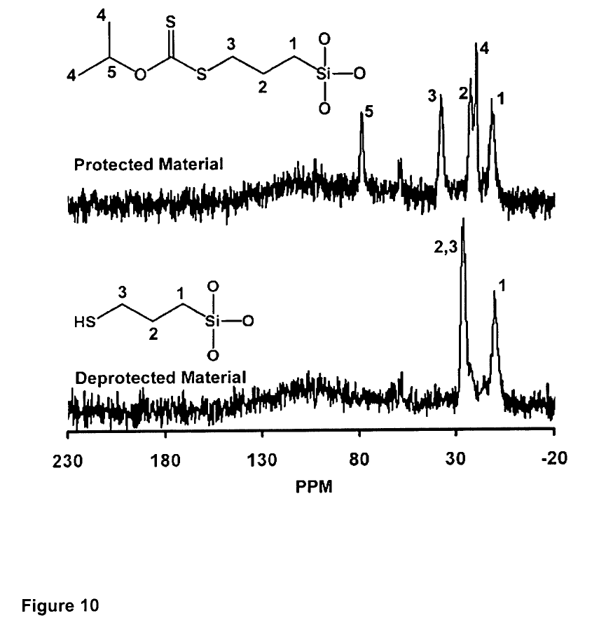

The imprinting of thiol groups in a bulk silica process was followed using ¹³C CP/MAS NMR (FIG. 10). The top spectrum shows a material upon condensation of imprint 14 with silica. After deprotection, as shown in the bottom spectrum, resonances associated with the xanthate-protecting group disappear, replaced by resonances from the resulting 3-mercaptopropyl tether.

Thermolysis was followed by high-resolution thermogravimetric analysis and mass spectrometry as shown in FIG. [11], in which a material imprinted with 4 was heated at a programmed ramp rate of 5° C./min under an inert nitrogen atmosphere. The rate of thermolysis became significant at approximately 140° C. where the rate of weight loss increased suddenly. This occurred concurrently with the detection of propene and carbonyl sulfide via mass spectroscopy of the effluent gas passed over the sample during heating. The maximum rate of thermolysis occurred at 200° C. and subsided sharply above 240° C. for this heating rate. This range is typical of temperatures employed for homogeneous thermolysis of xanthate protecting groups.¹⁵ After about 300° C., combustion of the remaining 3-mercaptopropyl organic groups began to occur.

Weight loss from the high-resolution thermogravimetric experiment provides only an upper bound on the amount of thermolyzed imprint, due to competing weight loss from dehydration and dehydroxylation of the silica surface. However, the number of accessible thiols was quantified by titration with Ellman's reagent, 5,5′-dithio-bis(2-nitrobenzoic acid).^{6,40,41} This procedure involved the derivatization of the thiol group and quantitative analysis by absorbance measurements of the liberated thio anion, 3-carboxyl-4-nitrothiophenolate as depicted in FIG. [5] (top). Thiols may also be selectively derivatized to form new functionalities by using other disulfide reagents, or they may be selectively oxidized to form an acidic sulfonic acid residue, FIG. [5s] (bottom).^{6,40,41}

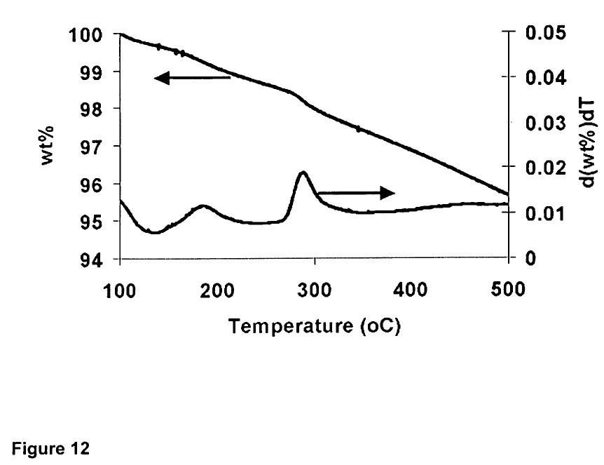

For the material containing both amine and thiol functionalities, thermolysis of material 8 to generate material 9 was followed by high-resolution thermogravimetric analysis and mass spectrometry as shown in FIG. 12 for a programmed ramp rate of 5° C./min in air. Thermolysis behavior was consistent with that observed for the carbamate and xanthate materials described previously, requiring no additional thermal driving force to achieve deprotection. The rate of thermolysis for both protecting xanthate and carbamate protecting groups overlapped appreciably throughout the temperature range investigated and became significant at approximately 140° C., where the rate of weight loss was observed to increase suddenly. The maximum rate of thermolysis occurred at 200° C. and subsided sharply above 240° C. at this heating rate. Combustion with the air purge was seen to begin above 280° C. Thus, there is a significantly large temperature window upon start of xanthate and carbamate thermolysis and before the beginning of combustion.

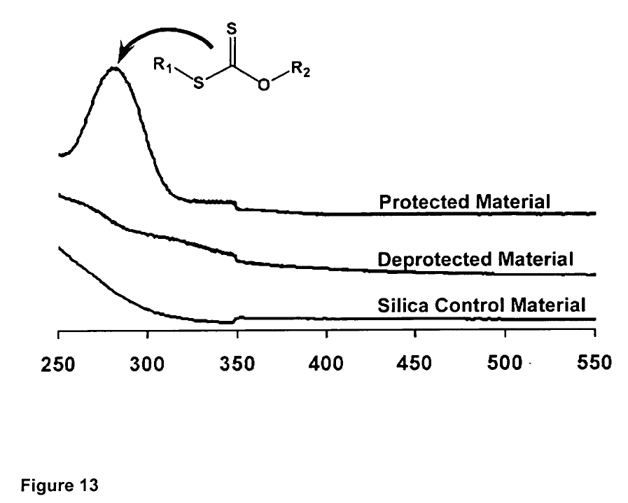

Thermolysis of xanthate-based imprints, including imprint 5, are amenable to study via solid-state UV/visible spectroscopy as shown in FIG. 13. The xanthate functionality has a characteristic adsorption around 280 nm that was lost upon its thermolysis for synthesizing 9, as seen in the difference between the top and middle spectra of FIG. 13. These materials were also characterized by techniques discussed previously including potentiometric titration, salicylaldehyde binding, and titration using Ellman's reagent. Titration with Ellman's reagent of accessible thiols in material 15 gave a value of 0.06 mmol/g, which accounts for greater than 80% accessibility as compared to the 0.07 mmol/g amines counted via nonaqueous potentiometric titration. These values are consistent with those predicted from the mass loss observed in the high-resolution thermogravimetric analysis. Taken together, these data indicate that the thiol-amine pairs resulting from the thermolysis of imprint 5 do indeed form in the expected 1 to 1 ratio on the substrate surface following their deprotection. This material is unique in that it represents the first known material to contain two different imprinted chemical functional groups arising from the same imprint molecule. As such, it offers the potential to organize two disparate entities on solid surfaces in close proximity to each other, as governed by the spacing of the thiol and amine on the imprinted substrate surface, which is controlled by their separation distance in the imprint 5. Further derivatization of either the amine or thiol is possible, such as selective oxidation of the thiol functionality or reaction with Ellman's reagent resulting in a material where an acid and a base are positioned relative to one another.

### EXAMPLES

The following procedures and techniques were used in the examples that follow.

¹H and ¹³C NMR spectroscopy were performed on Bruker AMX 300 and 400 MHz machines. Solid-state NMR spectroscopy was performed using a Bruker DSX 200 operating at 200 MHz and a spin rate of 4.0 kHz. UV/Vis spectroscopy was performed on a Varian Cary 400 Bio UV/Vis spectrophotometer equipped with a Harric Praying Mantis accessory for diffuse reflectance measurements on solids at room temperature. Non-aqueous potentiometric titrations were performed using a Brinkmann/Metrohm 765 Dosimat with an Accumet AR15 pH meter and a Corning High Performance glass combination electrode with a Silver Scavenger reference. Gas chromatography was performed on an Agilent 6890 GC system equipped with an FID detector. High-resolution thermogravimetric analysis was performed on a TA Instruments TGA 2950 system connected to an Inficon 074 Transpector with a quadrupole mass filter. Nitrogen physisorption was performed on a Quantachrome Autosorb-1 using samples that had been degassed for at least 20 hours at room temperature. Fluorescence measurements were performed on a Hitachi F-4500 spectrophotometer equipped with a solids accessory.

Ether (EM Science) was dried by distillation over sodium/benzophenone. Water was distilled, purified with a Barnstead Nanopure Infinity system to at least 18 Mohm purity, and passed through a 0.2 micron filter. 3-triethoxysilylpropyl)-t-butylcarbamate was purchased from Gelest. Unless otherwise reported, reagents were purchased from Aldrich and were used as received.

(3-triethoxysilylpropyl)-carbamic acid 1-methyl-cyclohexyl ester (imprint 2).

To a solution of 1-methylcyclohexanol (5.06 ml, 40.44 mmol) in ether (140 ml) at room temperature under N₂ was added methyllithium (1.4 M in ether, 1.64 ml, 2.3 mmol) dropwise. After 1 hour, the mixture was cooled to −40° C. in an acetonitrile/CO₂ bath and 3-(triethoxysilyl)propyl isocyanate (8.3 ml, 35.17 mmol) was added. After 2.5 hours, the solution was allowed to warm to room temperature. The mixture was concentrated to an oil and purified by silica chromatography (Silica Gel 60 and 6.0/1.0 v/v hexanes/ethyl acetate) to yield a clear oil (7.31 g, 20.2 mmol, yield 58%). ¹H NMR (CDCl₃): 0.614 (2H, t, J=8.0 Hz, CH₂); 1.209 (9H, t, J=6.8 Hz, Si(OCH₂CH₃)₃); 1.36-1.55 (8H, m, CH₂); 1.45 (3H, s, CH₃); 1.589 (2H, m, CH₂); 2.08 (2H, m, CH₂); 3.108 (2H, q, J=6.4 Hz, CH₂); 3.803 (6H, t, J=6.8 Hz, Si(OCH₂CH₃)₃); 4.768 (1H, m, NH). ¹³C NMR (CDCl₃): 7.61 (CH₂); 18.24 (CH₃); 22.14 (CH₂); 23.33 (CH₂); 25.46 (CH₃); 25.85 (CH₂); 36.97 (CH₂); 43.00 (CH₂); 58.38 (CH₂); 80.13 (C); 155.87 (C═O). Mass spectrum (FAB ¹H): m/z 362.237115 (¹HC₁₇H₃₅NO₅Si, 362.236277).

(3-triethoxysilylpropyl)-carbamic acid 1,1,3-trimethyl-3-(3-triethoxysilyl-propylcarbamolyloxy)-butyl ester (imprint 3). To a solution of 2,4-Dimethylpentane-2,4-diol (1.5 ml, 10.5 mmol) in ether (80 ml) at room temperature under N₂ was added methyllithium (1.4 M in ether, 0.5 ml, 0.7 mmol). After approximately 1 hour, the mixture was cooled to −77° C. and 3-(triethoxysilyl)propyl isocyanate (8.3 ml, 35.17 mmol) was added dropwise. The solution was allowed to warm to −40° C. in an acetonitrile/CO₂ bath. After approximately 8 hours, the solution was slowly warmed to room temperature while stirring overnight. The mixture was concentrated to an oil and purified by silica chromatography (Silica Gel 60 and 8.0/1.0 v/v hexanes/ethyl acetate) to yield a clear oil (1.33 g, 2.12 mmol, yield 20%). ¹H NMR (CDCl₃): 0.608 (4H, t, J=8.1 Hz, CH₂); 1.219 (18H, t, J=6.9 Hz, Si(OCH₂CH₃)₃); 1.467 (12H, s, CH₃); 1.585 (4H, m, CH₂); 2.461 (2H, s, CH₂); 3.109 (4H, q, J=6.6 Hz, CH₂); 3.811 (12H, t, J=6.9 Hz, Si(OCH₂CH₃)₃); 4.723 (2H, m, NH). ¹³C{¹H} NMR (CDCl₃): 7.57 (CH₂); 18.26 (CH₃); 23.34 (CH₂); 27.91 (CH₃); 42.97 (CH₂); 46.96 (CH₂); 58.40 (CH₂); 81.14 (C); 155.73 (C═O). Mass spectrum (FAB ⁷Li): m/z 633.379430 (7LiC₂₇H₅₈N₂O₁₀Si₂, 633.379008).

Silica Synthesis. Microporous imprinted silica was prepared according to procedures reported previously.² Mesoporous imprinted materials were prepared via the following procedure. In a typical synthesis, a mixture of tetraethyl orthosilicate (30 ml, 134.4 mmol), (3-triethoxysilylpropyl)-t-butylcarbamate (0.87 g, 2.7 mmol), and absolute ethanol (94.5 mL) was brought to reflux in a 250 mL round bottom two-necked flask equipped with a condenser. The solution was brought to reflux and the following aliquots were added at one hour intervals: 0.6 mL pH 2.0 p-toluenesulfonic acid in water, 0.6 mL pH 2.0 p-toluenesulfonic acid in water, 4.73 mL water, and 4.73 mL water. The solution was refluxed for one hour after the last water addition, and then added hot to a 16 oz jar containing 5.32 mL of a pH 12.4 solution of aqueous ammonium hydroxide. Upon subsequent gelation, the clear solid was placed in a 40° C. oven and allowed to dry for 10 days. The resulting silica monoliths were ground into particles less than 10 micron in diameter using a planetary mill and repetitive wet-sieving in absolute ethanol. The material was then dried in air overnight and stored in a desiccator.

High-Resolution Thermogravimetric Analysis and Thermolysis (Imprint Deprotection). Analysis was performed using samples (from 10 to 300 mg) in a N₂ environment (30 ml/min) and an alumina or Pt pan. For thermolytic imprint deprotection, samples were first purged of O₂ over a 10 h period at room temperature and then subjected to a temperature programmed heating at a rate of 1° C./min to a final temperature of 240° C.

Potentiometric Titration. In a typical procedure,⁴² 15 to 150 mg of silica were suspended in glacial acetic acid (approximately 40 ml) until the voltage stabilized. The mixture was titrated with a 0.1 N solution of perchloric acid in glacial acetic acid using 5 to 20 μl doses every 300 to 720 seconds.

Fluorescence Investigation Procedures. To a solution of 4-pyrenebutyraldehyde in methanol was added a sufficient amount of silica material as to achieve binding of 0.15 mmol aldehyde/g material. Thus 3 ml of a 3 mM aldehyde solution was mixed with 50 mg surface-functionalized material (0.065 mmol amine, 0.14 eq), and, separately, 1.7 ml of a 12.7 mM solution was mixed with 50 mg imprinted silica (0.011 mmol amine, 2 eq). The solutions were stirred for 18 h at room temperature and uptake monitored by UV/Vis spectrophotometry using an extinction coefficient of 42,200 M⁻¹. Materials were then filtered, washed with a combination of acetonitrile (60 ml), chloroform (30 ml), and pentane (60 ml), and Soxhlet extracted in chloroform for 16 h. Measurements used a 700 V excitation voltage, a 15 nm/min scan rate, 2.5 nm excitation/emission slit widths, and a 340 nm excitation wavelength.

Salicylaldehyde Binding. For solid-state UV/Vis experiments, a solution of salicylaldehyde (2.65 ml, 0.005 M, 2 eq) in acetonitrile was added to 30 mg imprinted silica under constant stirring at room temperature. After at least 2.5 h, the materials were filtered, washed with a combination of 100 ml acetonitrile, 100 ml chloroform, and 50 ml pentane, and subsequently Soxhlet extracted in chloroform for 16 h. Samples prepared for quantitative binding experiments used 1,3,5-trimethoxybenzene as an internal standard, with binding monitored via GC using syringe filtered samples.

### Example 1

Use of Imprinted Amines Synthesized via Thermolysis to Construct a “Ship-in-the-Bottle” Type Catalyst. The synthesis of bulk imprinted silica using thermolysis is a useful method for synthesizing a catalyst that prevents the leaching of metal during liquid-phase catalytic processes, by encapsulation of the metal within a hydrophobic pocket from which it cannot escape. This can be applicable to a variety of liquid-phase catalytic processes such as oxidation, as well as palladium catalyzed carbon-carbon bond formation based on coupling reactions, to name only a few types of reactions. In all of these applications, a ubiquitous problem leading to loss of catalyst and downstream metal contamination involves leaching of catalyst in the form of metal particles or ions from the solid surface.

An imprinting-based solution to this problem is to build a hydrophobic micropore surrounding the catalytic active site—a type of ship-in-the bottle approach—which makes it impossible for the polar catalyst to escape due to cation encapsulation as shown in the scheme below. Thus, for the case of palladium catalyst, a bulk imprinted silica synthesized using thermolysis as described in this disclosure is used to anchor a palladium ligand to the amines within the imprinted pockets. The palladium is then bound to the hydrophilic, ligand-containing material. The processes for ligand binding to immobilized amines on silica and the palladium binding to the immobilized ligand assembly are described well in the prior art (see for example “A novel Suzuki reaction system based on a supported palladium catalyst” by E. B. Mubofu, J. H. Clark, and D. J. Macquarrie). Afterwards, with the palladium bound to the ligand within the imprinted pocket, framework silanols can be capped with a hydrophobic group, such as a trimethylsilyl group. This can be performed by treating the material under neutral conditions with a neat equimolar mixture of 1,1,1,3,3,3-hexamethyldisilazane and chlorotrimethylsilane in a manner well-known in the art of the invention. This last treatment renders the framework hydrophobic and encapsulates the bound metal so that it is unable to leach from the imprinted site, because it is blocked by the hydrophobic trimethylsilyl groups of the framework. The effect of the encapsulation can be deduced from data in imprinted catalysts prepared using thermolysis, in which the silanol groups are replaced with hydrophobic trimethylsilyl groups. The resulting amines encapsulated within a hydrophobic pocket are inaccessible to polar reagents such as 2,4,6-trinitrobenzenesulfonic acid and metal cations such as Cu(II), which are known to coordinate to amines, due to extremely low solubility of the reagents within the framework. This method of metal cation immobilization using palladium can be directly used as a leach-proof catalyst for the Suzuki, Heck, and Sonogashira coupling reactions, which have significant practical application within the pharmaceutical industry, where palladium leaching remains a significant problem (see for example “A Simple, Recyclable Polymer-Supported Palladium Catalyst for Suzuki Coupling—An Effective Way to Minimize Palladium Contamination” by Shieh, W.-C.; Shekhar, R.; Blacklock, T. and Tedesco, A., Synthetic Communications 2002, 32, 1059-1067).

### Example 2

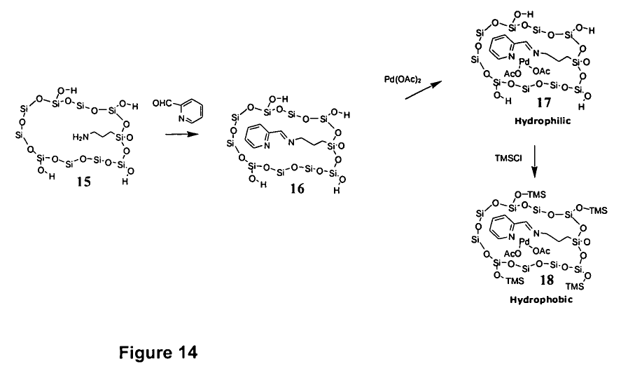

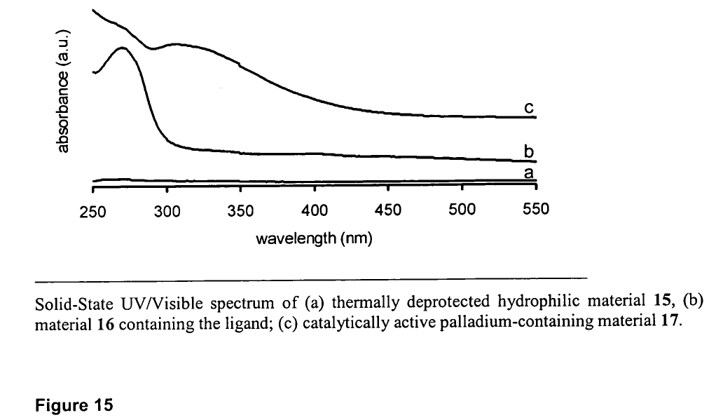

Production and use of imprinted materials containing a catalytically active palladium complex. We extended the approach described above by controlling the active site environment via framework modification for an organometallic catalyst, through the synthesis of a tethered palladium complex within the imprinted pocket of 15. The approach is illustrated in FIG. 14. First, a bulk imprinting procedure was used to synthesize the site-isolated hydrophilic starting material 15.²⁹ Adapting previously published procedures for the synthesis of a Suzuki coupling catalyst,⁴³ a ligand was introduced by treating the imprinted primary amine with 2-pyridinecarboxyaldehyde, yielding material 16. Palladium was then introduced to synthesize hydrophilic catalyst 17. For the ligand, quantitative binding was achieved by contacting 1.1 equivalents of aldehyde (0.017 M in chloroform) with 15 at room temperature followed by filtration, chloroform wash, and vacuum drying. The palladation of 17 was performed in acetone (0.033 M palladium acetate, 1.1 eq) at room temperature and monitored by liquid UV/Visible spectrophotometry (ε=246.5 M⁻¹ at 400 nm) to proceed to complete binding with the ligand in 17. This material was subsequently filtered, washed with acetone, and dried under vacuum. Hydrophobic material 19 was synthesized by end-capping silanol groups under neutral conditions using established procedures.^{2,3} Both hydrophilic 17 and hydrophobic 18 materials were then Soxhlet extracted in acetone to remove any residual physisorbed materials. The catalytic materials were investigated using solid-state UV/Visible spectroscopy at each stage of the synthesis process. These spectra are shown in FIG. 15. New bands associated with the ligand and the palladation are clearly visible at 270 nm and 305 nm, respectively.

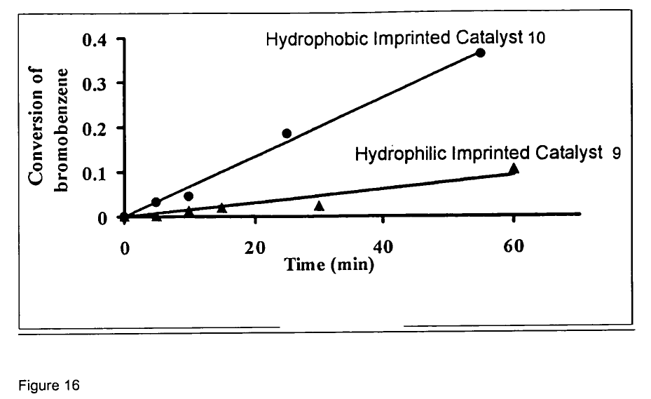

The hydrophilic 17 and hydrophobic 18 palladium catalysts were then used in the Suzuki coupling of bromobenzene and phenylboronic acid. FIG. 16 shows representative data from such a catalytic experiment. The activity of the catalysts as a function of the hydrophobicity of the silica framework was measurable, but not as dramatic for the Suzuki coupling as it was in the Knoevenagel system described above. Notably, it is the hydrophobic 18 outer sphere environment that shows the higher activity in this catalytic system, in contrast with the Knoevenagel reaction described above, showing a factor of 3 higher initial turnover frequency relative to hydrophilic catalyst 17. Solvent effects have been previously observed in Suzuki coupling reactions.⁴⁴ In our case the framework is functioning as the equivalent of a solvent that controls the environment at the active site.

Previous studies have shown the absence of significant palladium leaching in this system during catalysis.⁴³ We investigated whether the coordination geometry surrounding the Pd, as ascertained via solid-state UV/Visible spectroscopy, changes before and after catalysis and after typical recycle procedures following a catalytic experiment. These recycle procedures involve washing the catalyst with dichloromethane and water, for removing excess potassium carbonate base, and drying under vacuum after subjecting the catalysts to one hour of reaction time.⁴³ The results of the spectroscopic analysis are akin to the spectrum FIG. 15c and do not show any significant changes for catalysts 17 and 18 before reaction and after the first recycle. These results are consistent with those of Macquarrie et al. indicating the absence of significant Pd leaching in this system.

### Example 7

thiol imprinting. Imprint 4. To a solution of O-isopropylxanthic acid potassium salt (525 mg, 3 mmol) in acetone (15 ml) at room temperature under N₂ was added 3-iodopropyltriethoxysilane (1.0 g, 3 mmol) in 10 ml acetone dropwise. After 24 hours, the mixture was filtered through silica, reduced via rotary evaporation, and purified by silica chromatography (Silica Gel 60, hexanes/ethyl acetate) to yield a pale yellow oil (0.84 g, 2.5 mmol, yield 82%). ¹H NMR (CDCl₃): 0.752 (2H, t, J=8.0 Hz, CH₂); 1.223 (9H, t, J=6.8 Hz, Si(OCH₂CH₃)₃); 1.395 (6H, d, J=6.0 Hz, CH₃); 1.814 (2H, q, J=8.0 Hz, CH₂); 3.124 H, t, J=7.6 Hz, CH₂); 3.814 (6H, t, J=6.8 Hz, Si(OCH₂CH₃)₃); 5.776 (1H, q, J=6.4, CH). ¹³C NMR (CDCl₃): 10.08 (CH₂); 18.24 (CH₃); 21.3 (CH₃); 22.28 (CH₂); 38.42 (CH₂); 58.42 (CH₂); 77.55 (CH); 214.27 (C═S).

Imprint 5. Under N₂, potassium hydroxide (1.6 g, 28.5 mmol), was added to a solution of 2-methyl-2,4-pentanediol (15 ml, 117 mmol) in 4 ml dimethylsulfoxide and heated to 95° C. to dissolve. Upon cooling to room temperature, carbon disulfide (1.8 ml, 30 mmol) was added dropwise in an ice bath to keep the temperature below 30° C. After thirty minutes ether was added and the solid product was filtered off. Washing with 3 portions of ether yielded a yellow solid (4.72 g, 72% yield). A portion of this solid (1.05 g, 4.5 mmol) was added to 25 ml acetone under N₂. To this mixture was added 3-iodopropyltriethoxysilane (1.5 g, 4.5 mmol) in 15 ml acetone dropwise. After 24 hours, ether was added and the mixture filtered through silica (2×). Reduction under vacuum and purification via silica chromatography (Silica Gel 60, hexanes/ethyl acetate) yielded a pale yellow oil (1.13 g, 63% yield). A portion of this product (500 mg, 1.25 mmol) in dry THF was added along with triethoxy(3-isocyanatopropyl)silane (0.28 ml, 1.13 mmol). To this a catalytic amount of dibutyl tin dilaurate was added and the mixture allowed to react for 3 days at 75° C. The mixture was concentrated to an oil and purified by silica chromatography (Silica Gel 60, hexanes/ethyl acetate) to yield a clear oil (0.33 g, 0.52 mmol, yield 41%). ¹H NMR (CDCl₃): 0.580 (2H, m, CH₂); 0.720 (2H, m, CH₂); 1.196 (18H, m, Si(OCH₂CH₃)₃); 1.319 (3H, d, J=6.4 Hz CH₃); 1.440 and 1.391 (6H, CH₂); 1.565 (2H, q, J=6.8 Hz, 8.0 Hz, CH₂); 1.769 (2H, m, CH₂); 2.194 (2H, m, CH₂); 3.102 (4H, m, CH₂); 3.789 (12H, m, Si(OCH₂CH₃)₃); 4.787 H, m, NH); 5.917 (1H, m, CH). ¹³C{¹H} NMR (CDCl₃): 7.55 (CH₂); 10.01 (CH₂); 18.24 (CH₃); 20.54 (CH₂); 22.14 (CH₂); 23.22 (CH₂); 23.22 (CH₂); 26.66 (CH₂); 27.27 (CH₃); 38.43 (CH₂); 43.02 (CH₂); 45.79 (CH₂); 58.37 (CH₂); 77.81 (CH); 79.43 (C); 155.73 (C═O); 214.3 (C═S). Mass spectrum (FAB ⁷Li): m/z 652.303680 (7LiC₂₇H₅₈N₂O₁₀Si₂, 652.301688).

It is understood that the examples and embodiments described herein are for illustrative purposes only and that various modifications or changes in light thereof will be suggested to persons skilled in the art and are to be included within the spirit and purview of this application and scope of the appended claims.

All publications, patents, and patent applications cited herein are hereby incorporated by reference in their entirety for all purposes.

### REFERENCES

1. (a) Wulff, G. Chem. Rev. 2002, 102, 1. (b) Davis, M. E., Katz. A., Chem. Mater. 1996, 8, 1820.
2. Katz, A.; Davis, M. E. Nature 2000, 403, 286.
3. Katz, A. Ph.D. thesis, California Institute of Technology, Pasadena, Calif., 1999.
4. Graham, A. L.; Carlson, C. A.; Edmiston, P. L. Anal. Chem. 2002, 74, 458-467.
5. (a) Wulff, G.; Heide, B.; Helfineier G. J. Am. Chem. Soc. 1986, 108, 1089-1091. (b) Hwang, K.-O.; Yakura, Y.; Ohuchi, F. S.; Sasaki, T. Materials Science and Engineering: C 1995,3,137-141.
6. Dufaud, V.; Davis, M. E. J. Am. Chem. Soc. 2003, 125, 9403-9413.
7. Ki, C. D.; Oh, C.; Oh, S.-G.; Chang, J. Y. J. Am. Chem. Soc. 2002,124,14838.
8. Klemm, L. H.; Antoniades, E. P.; Lind, C. D. J. Org. Chem. 1962, 27, 519-526.
9. Martin, G.; Martinez, H.; Ascanio, J. International Journal of Chemical Kinetics 1990, 22, 1127-1136.
10. Martin, G.; Martinez, H. International Journal of Chemical Kinetics 1987,19,1053-1062.
11. Martin, G.; Martinez, H.; Ascanio, J. International Journal of Chemical Kinetics 1989, 21, 193-206
12. Gazizov, T. Kh.; Chugonov, Yu. V.; Pudovik, A. N. Doklady Akademii Nauk SSSR 1987, 294, 1382-1386.
13. Coles, M. P.; Lugmair, C. G.; Terry, K. W.; Tilley, T. D. Chem. Mat. 2000,12,122-131.
14. Taylor, R.; Thorne, M. P. Journal of the Chemical Society Perkin Transactions II 1976, 799-802.
15. March, J. “Advanced Organic Chemistry” 4^{th} Ed. John Wiley & Sons, New York, 1992 pp. 1014-1015 and references therein.
16. Brinker, C. J.; Keefer, K. D.; Schaefer, D. W.; Ashley, C. S. J. Non-Cryst. Solids 1982, 48, 47.
17. Brinker, C. J.; Keefer, K. D.; Schaefer, D. W.; Assink, R. A.; Ashley, C. S. J. Non-Cryst. Solids 1984, 63, 45.
18. Cao, G.; Tian, H. J. Sol-Gel Sci. Technol. 1998, 13, 305.
19. Rawal, H. V.; Jones, R. J.; Cava, M. O. J. Org. Chem 1987, 52, 19.
20. Houlihan, F. M.; Reichmanis, E.; Tarascon, R. G.; Taylor, G. N.; Hellman, M. Y.; Thompson, L. F. Macromolecules, 1989, 22, 2999.
21. Ahn, K. D.; Lee, Y.-H.; Koo, D. I. Polymer, 1992, 33, 4851.
22. Ahn, K. D.; Koo, D. I.; Wilson, C. G. Polymer, 1995, 36, 2621.
23. Tully, D. C.; Trimble, A. R.; Frechet, J. M. J. Adv. Mater. 2000, 12, 1118.
24. Pak, C.; Bell, A. T.; Tilley, T. D. J. Catal. 2002, 194, 431.
25. Male, J. L.; Niessen, H. G.; Bell, A. T.; Tilley, T. D. J. Catal. 2000, 194, 431.
26. Hunnius, M.; Rufińska, A. Maier, W. F. Micropor. Mesopor. Mat. 1999, 29, 389.
27. Pinel, C.; Loisil, P.; Gallezot, P. Adv. Mater. 1997, 9, 582.
28. Boury, B.; Corriu, R. J. P.; Le Strat, V.; Delord, P. New J. Chem. 1999, 23, 531.
29. Park, J.-W.; Thomas, E. L. J. Am. Chem. Soc. 2002, 124, 514-515.
30. (a) Park, J.-W.; Thomas, E. L. Adv. Mater. 2003, 15, 585-588. (b) Jon, S.; Seong, J.; Khademhosseini, A.; Tran, T.-N. T.; Laibinis, P. E.; Langer, R. Langmuir 2003, 19, 9989-9993.
31. Bates, F. S. Science 1991, 251, 898-905.
32. Bass, J. D.; Katz, A.; Chem. Mater. 2003, 15, 2757-2763.
33. Kamounah, F. S. Spectrosc. Lett., 1992, 25, 513.
34. Lewis, J. W.; Sandorfy, C. Can. J. Chem. 1982, 60, 1727.
35. Dutta, P. K; Turbeville, W. J. Phys. Chem. 1991, 95, 4087.
36. Turbeville W. and Dutta D. K., J. Phys. Chem. 1990, 94: 4060.
37. Casades, I.; Álvaro, M.; Garcia, H.; Pillai, M. N. Eur. J. Org. Chem. 2002, 2074.
38. Lee, T.; Jones, J. B. J. Amer. Chem. Soc. 1997, 119, 10260.
39. Nishiguchi, T.; Taya, H. J. Amer. Chem. Soc. 1989, 111, 9102.
40. Badley R. D., Ford W. T., J. Org. Chem. 1989, 54, 5437-5443.
41. Margolese D., Melero J. A., Cheristiansen S. C., Chmelka B. F., Stucky G. D., Chem. Mater. 2000, 12, 2448-2459.
42. Gyenes, I. Titration in non-aqueous media; Van Nostrand: London, 1967.
43. Mubofu, E. B.; Clark, J. H.; Macquarrie, D. J. Green Chem. 2001, 3, 23-25.
44. LeBlond, C. R.; Andrews, A. T.; Sun, Y. K.; Sowa, J. R. Org. Let. 2001, 3, 1555-1557.

1. A process for producing an inorganic oxide imprinted with a plurality of functional groups, comprising:
(a) contacting the inorganic oxide or a source thereof with an imprinting compound comprising (i) a plurality of functional moieties to be imprinted, (ii) a plurality of thermally labile protecting groups and (iii) a silicon- or germanium-containing moiety capable of serving as a linker for the imprinting compound to the inorganic oxide to form an inorganic oxide structure comprising immobilized imprinting compound; and
(b) removing a thermally labile portion of the imprinting compound from the oxide structure by thermolysis

2. A process for producing an inorganic oxide imprinted with a functional group, comprising:
(a) contacting the inorganic oxide or a source thereof with an imprinting compound comprising (i) a functional moiety to be imprinted, (ii) a thermally labile protecting group and (iii) a silicon- or germanium-containing moiety capable of serving as a linker for the imprinting compound to the inorganic oxide to form an inorganic oxide structure comprising immobilized imprinting compound; and
(b) removing a thermally labile portion of the imprinting compound from the oxide structure by thermolysis;
provided that if the oxide structure is an oxide substrate imprinted with a single functional group, then the imprinted group is other than isocyanate and the thermally labile protecting group is other than a carbamate of an aryl alcohol.

3. A process for producing a bulk imprinted inorganic oxide imprinted with one or a plurality of functional groups, comprising:
(a) copolymerizing a source of the organic oxide with an imprinting compound comprising (i) one or a plurality of functional moieties to be imprinted, (ii) one or a plurality of thermally labile protecting groups, and (iii) a silicon- or germanium-containing moiety capable of serving as a linker for the imprinting compound to the inorganic oxide to form an inorganic oxide structure comprising immobilized imprinting compound; and
(b) removing a thermally labile portion of the immobilized imprinting compound from the oxide structure by thermolysis.

4. A process for producing an inorganic oxide substrate imprinted with one or a plurality of functional groups, comprising:
(a) contacting a substrate comprising the inorganic oxide with an imprinting compound comprising (i) one or a plurality of functional moieties to be imprinted, (ii) one or a plurality of thermally labile protecting groups for the functional moieties, and (iii) a silicon- or germanium-containing moiety capable of serving as a linker for the imprinting compound to the inorganic oxide to form an inorganic oxide structure comprising immobilized imprinting compound; and
(b) removing a thermally labile portion of the imprinting compound by means of thermolysis;
provided that if the oxide structure is an oxide substrate imprinted with a single functional group, then the imprinted group is other than isocyanate and the thermally labile protecting group is other than a carbamate of an aryl alcohol moiety.

5. A process according to claim 1 in which the inorganic oxide comprises silica, germania, alumina, titania, one or more aluminophosphates, one or more silicaaluminophosphates, ceria, indium-tin oxide, or a mixture thereof.

6. A process according to claim 5 in which the inorganic oxide comprises silica.

7. A process according to claim 1 in which the inorganic oxide is a bulk oxide.

8. A process according to claim 1 in which the inorganic oxide is in the form of an oxide substrate.

9. A process according to claim 4 in which the inorganic oxide substrate comprises a particulate inorganic oxide.

10. A process according to claim 4 in which the inorganic oxide comprises a generally planar surface.

11. A process according to claim 1 in which the thermolysis is conducted by heating the product of step (a).

12. A process according to claim 11 in which the thermolysis is conducted by heating the product of step (a) at a temperature of from about room temperature to about 300° C.

13. A process according to claim 11 in which the thermolysis is conducted by heating the product of step (a) at a temperature of from about 90 to about 300° C.

14. A process according to claim 11 in which the thermolysis is conducted by heating the product of step (a) at a temperature of from about 120 to about 300° C.

15. A process according to claim 11 in which the thermolysis is conducted by heating the product of step (a) at a temperature of from about 240 to about 300° C.

16. A process according to claim 1 in which the thermolysis is conducted by subjecting the product of step (a) to electromagnetic radiation or to sonication.

17. A process according to claim 1 in which the functional moiety or plurality of moieties is selected from amine, thiol, isocyanate, carboxyl, hydroxyl, phenoxyl, phosphate and titanate.

18. A process according to claim 1 in which the oxide is imprinted with two or more different functional moieties.

19. A process according to claim 18 in which the oxide is imprinted with amine and thiol moieties.

20. A process according to claim 1 in which the functional moiety comprises an amine moiety or a plurality of amine moieties.

21. A process according to claim 20 in which the thermally labile protecting group comprises a carbamate.

22. A process according to claim 21 in which the carbamate is produced from an alcohol.

23. A process according to claim 22 in which the alcohol is a tertiary alcohol.

24. A process according to claim 23 in which the tertiary alcohol is t-butanol.

25. A process according to claim 23 in which the tertiary alcohol is 1-methylcyclohexanol.

26. A process according to claim 22 in which the alcohol is a multifunctional alcohol containing two or more hydroxyl groups.

27. A process according to claim 22 in which the alcohol is 2,4-dimethylpentane-2,4-diol.

28. A process according to claim 1 in which the functional moiety comprises a thiol moiety or a plurality of thiol moieties.

29. A process according to claim 28 in which the thermally labile protecting group comprises a xanthate.

30. A process according to claim 1 further comprising derivatizing or further reacting the imprinted moieties.

31. A process according to claim 30 in which amine and/or thiol groups are contacted with a source of metal ion or with a semiconductor.

32. A process according to claim 31 in which the amine and/or thiol groups are contacted with a metal ion.

33. A process according to claim 32 in which the metal ion is a transition metal ion.

34. An inorganic oxide substrate comprising four or more thermolytically imprintable functional moieties; said functional moieties organized in a non-random pattern on the substrate.

35. An inorganic oxide substrate according to claim 34 in which the functional moieties are selected from amine, thiol, isocyanate, carboxyl, hydroxyl, phenoxyl, phosphate and titanate.

36. An inorganic oxide substrate according to claim 34 in which the non-random pattern comprises pairs of two different functional moieties separated from each other by substantially similar distances.

37. An inorganic oxide substrate according to claim 36 in which the functional moieties are amine and thiol moieties.

38. An inorganic oxide substrate according to claim 34 in which the pattern is a one-dimensional pattern.

39. An inorganic substrate according to claim 34 in which the pattern is a two-dimensional pattern.

40. An inorganic oxide substrate according to claim 34 in which the functional moieties do not comprise a self-assembled monolayer.

41. An inorganic oxide substrate according to claim 40 further comprising metal ions or semiconductor molecules linked to the functional moieties.

42. An inorganic oxide substrate according to claim 40 in which the pattern comprises dimensions smaller than about 100 nm and larger than about 0.5 nm.

43. An inorganic oxide substrate imprinted with a plurality of functional moieties selected from amine, thiol, isocyanate, carboxyl, hydroxyl, phenoxyl, phosphate and titanate.

44. An inorganic oxide substrate according to claim 43 imprinted with four or more of said functional moieties.

45. A particulate inorganic substrate according to claim 43.

46. A generally planar inorganic substrate according to claim 43.

47. An inorganic substrate according to claim 43 in which the inorganic oxide comprises silica, germania, alumina, titania, one or more aluminophosphates, one or more silicaaluminophosphates, ceria, indium-tin oxide, or a mixture thereof.

48. An inorganic oxide substrate according to claim 43 in which the inorganic oxide comprises silica.

49. An inorganic oxide substrate according to claim 43 in which the functional moieties are imprinted in an ordered fashion.

50. An inorganic oxide substrate according to claim 49 in which the ordered fashion is a one-dimensional pattern.

51. An inorganic oxide substrate according to claim 49 in which the ordered fashion is a two-dimensional pattern

52. An inorganic oxide substrate according to claim 43 imprinted with a plurality of amine moieties.

53. An inorganic oxide substrate according to claim 43 imprinted with a plurality of thiol moieties.

54. An inorganic oxide substrate according to claim 43 imprinted with a plurality of amine and thiol moieties.

55. An inorganic oxide substrate according to claim 43 further comprising a metallic structure having nanometric dimensions bonded to the substrate by means of the imprinted functional moieties.

56. A hydrophilic bulk inorganic oxide imprinted with one or more isolated functional moieties selected from amine, thiol, isocyanate, carboxyl, hydroxyl, phenoxyl, phosphate and titanate.

57. A hydrophilic bulk inorganic oxide according to claim 56 comprising a silica imprinted with amine groups.

58. A hydrophilic bulk inorganic oxide according to claim 56 with a plurality of voids, each comprising a plurality of amine groups.

59. A hydrophilic bulk inorganic oxide according to claim 56 comprising a silica imprinted with thiol groups.

60. A hydrophilic bulk inorganic oxide imprinted with one or more amine or thiol functional moieties, further comprising a catalytically active metal, and having substantially no capping of free hydroxyl groups.

61. A hydrophilic bulk inorganic oxide according to claim 60 in which the metal is a transition metal.
